(19) United States
(12) Patent Application Publication
(10) Pub. No.: US 2026/0129666 A1
(43) Pub. Date: May 7, 2026

(54) SYSTEMS AND METHODS ASSOCIATED WITH CHANNEL-AWARE DATA MULTIPLEXING

(71) Applicant: InterDigital Patent Holdings, Inc., Wilmington, DE (US)

(72) Inventors: Faris Alfarhan, Montreal (CA); Samuli Turtinen, Ii (FI); Paul Marinier, Brossard (CA); Tuong Duc Hoang, Montreal (CA); Francois Periard, Montreal (CA); Mario Hudon, Brossard (CA)

(73) Assignee: InterDigital Patent Holdings, Inc., Wilmington, DE (US)

(21) Appl. No.: 18/939,269

(22) Filed: Nov. 6, 2024

(51) Int. Cl. H04W 72/542; H04W 72/1268; H04W 88/02

(52) U.S. Cl. CPC H04W 72/542; H04W 72/1268; H04W 88/02

(57) ABSTRACT

Disclosed herein are systems, methods, and instrumentalities associated with data allocation or multiplexing. A wireless transmit/receive unit (WTRU) may receive an uplink transmission grant from a network device and determine a threshold condition associated with allocating data based on a sub-transport block (sub-TB) unit size. Based on a determination that the threshold condition is satisfied if a first set of data is allocated to a first portion of a transport block (TB) and a second set of data is allocated to a second portion of the TB, the WTRU may allocate the first set of data to the first portion of the TB and the second set of data to the second portion of the TB, wherein at least one of the first portion or the second portion of the TB may have a size equal to the sub-TB unit size. The WTRU may then transmit the TB using the uplink transmission grant and based on the sub-TB unit size.

### BACKGROUND

A wireless communication system may experience different channel conditions, power levels, and/or reliability requirements. Systems and methods that take these factors into account may improve the performance and efficiency of the communication system.

### SUMMARY

Disclosed herein are systems, methods, and instrumentalities associated with data allocation or multiplexing. According to embodiments of the disclosure, a wireless transmit/receive unit (WTRU) may be configured to receive an uplink transmission grant from a network device and determine a threshold condition associated with allocating data based on a sub-transport block (sub-TB) unit size. Based on a determination that the threshold condition is satisfied if a first set of data is allocated to a first portion of a transport block (TB) and a second set of data is allocated to a second portion of the TB, the WTRU may allocate the first set of data to the first portion of the TB and the second set of data to the second portion of the TB, wherein at least one of the first portion or the second portion of the TB may have a size equal to the sub-TB unit size. The WTRU may then transmit the TB using the uplink transmission grant and based on the sub-TB unit size.

In examples, the WTRU may be further configured to receive configuration information from the network device that may indicate the sub-TB unit size. In examples, the threshold condition may be related to a transmission power of the WTRU, and the threshold condition may be determined to be satisfied if a power headroom of the WTRU is above a threshold value. In examples, the threshold condition may be determined to be satisfied by calculating an amount of transmission power allocated to a unit of data (e.g., a data bit or a number of data bits of a physical resource block) in the TB, and determining that the amount of transmission power is above a threshold value.

In examples, the threshold condition may be further related to a mobility state of the WTRU or a channel measurement of the WTRU. In examples, the WTRU may determine that the threshold condition is satisfied further based on a determination that the first set of data and the second set of data may be associated with a specific data type or a specific priority. In examples, the WTRU may determine that the threshold condition is satisfied further based on a determination that the first set of data and the second set of data may be associated with a specific logical channel or a specific quality of service (QoS) requirement.

In examples, the WTRU may be further configured to transmit an indication to the network device that the transmission of the TB is based on the sub-TB unit size. In examples, the uplink transmission grant may be large enough to accommodate a third portion of the TB and, based on a determination that the threshold condition is no longer satisfied, the WTRU may exclude one or more physical resource blocks (PRBs) associated with the third portion from the transmission of the TB (e.g., such that the third portion of the TB may not consume any transmission power).

### BRIEF DESCRIPTION OF THE DRAWINGS

FIG. 1A is a system diagram illustrating an example communications system in which one or more disclosed embodiments can be implemented.

FIG. 1B is a system diagram illustrating an example wireless transmit/receive unit (WTRU) that can be used within the communications system illustrated in FIG. 1A according to an embodiment.

FIG. 1C is a system diagram illustrating an example radio access network (RAN) and an example core network (CN) that can be used within the communications system illustrated in FIG. 1A according to an embodiment.

FIG. 1D is a system diagram illustrating a further example RAN and a further example CN that can be used within the communications system illustrated in FIG. 1A according to an embodiment.

FIG. 2 is a diagram illustrating an example of a traffic scheduling regulator.

FIG. 3 is a diagram illustrating examples of UL traffic arrival and departure functions at a WTRU buffer.

FIG. 4 is a diagram illustrating an example of prioritization between data flows competing for resources on a grant.

FIG. 5 is a diagram illustrating an example of a leaky bucket traffic departure shaper.

FIG. 6 is a diagram illustrating an example of a dual leaky bucket traffic departure shaper.

FIG. 7 is a diagram illustrating an example of a data plane.

### DETAILED DESCRIPTION

A more detailed understanding can be had from the following description, given by way of example in conjunction with the accompanying drawings.

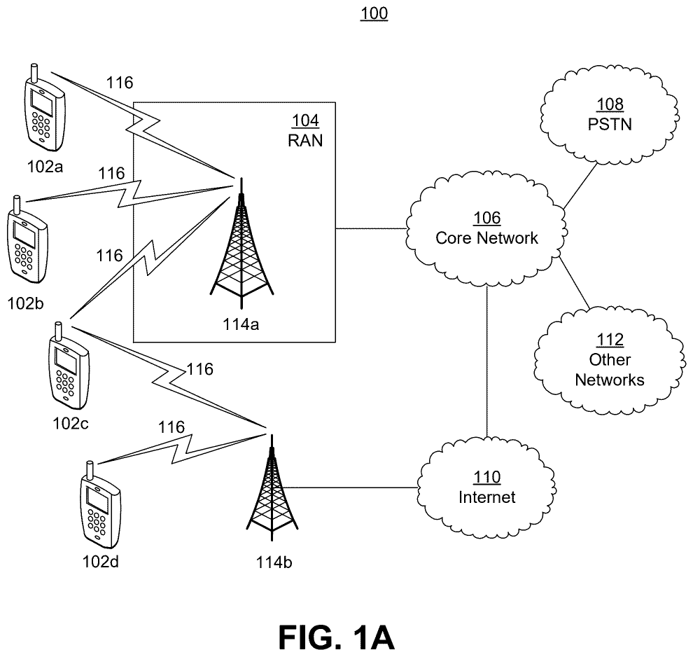

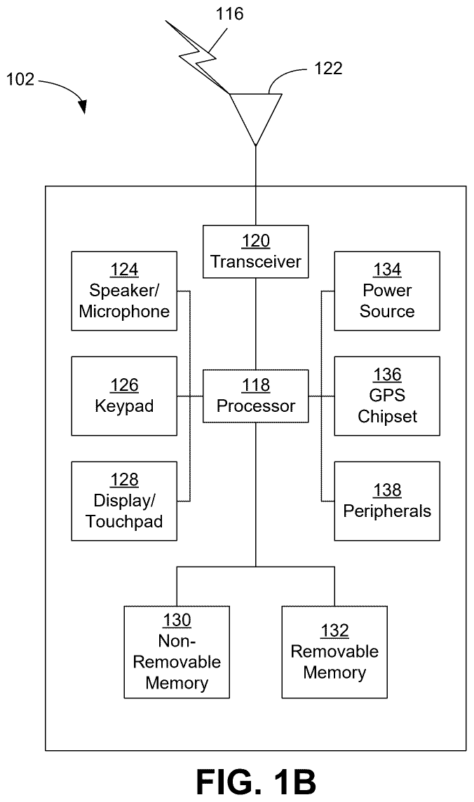

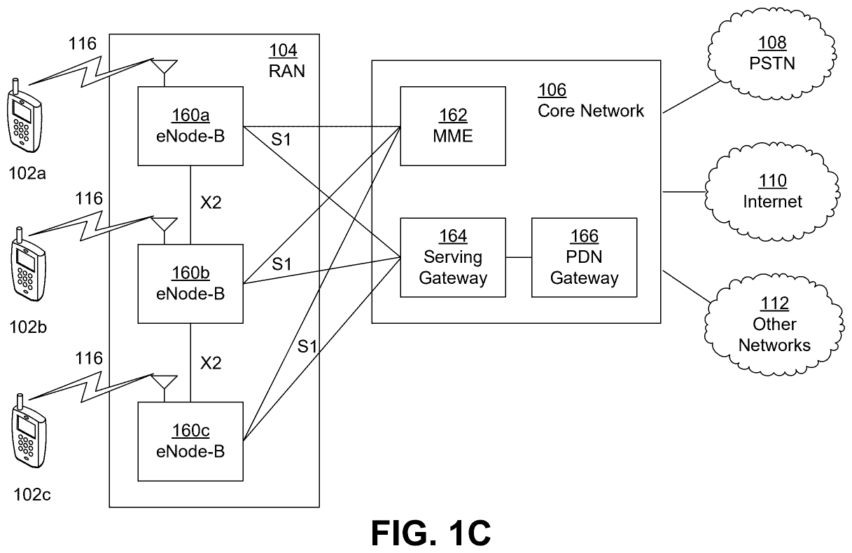

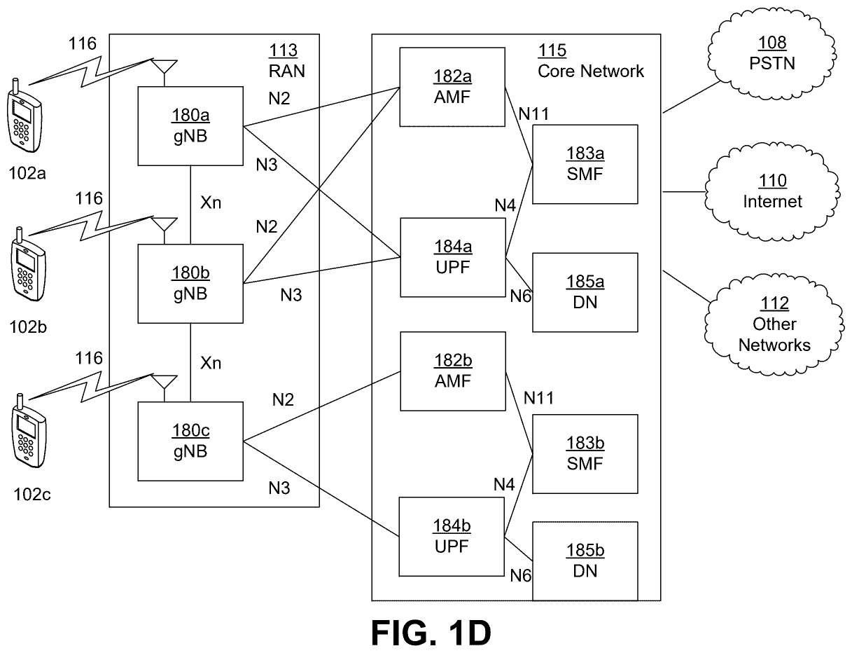

FIG. 1A is a diagram illustrating an example communications system 100 in which one or more disclosed embodiments can be implemented. The communications system 100 can be a multiple access system that provides content, such as voice, data, video, messaging, broadcast, etc., to multiple wireless users. The communications system 100 can enable multiple wireless users to access such content through the sharing of system resources, including wireless bandwidth. For example, the communications systems 100 can employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 can include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d can be any type of device configured to operate and/or communicate in a wireless environment. By way of example, the WTRUs 102a, 102b, 102c, 102d, any of which can be referred to as a “station” and/or a “STA”, can be configured to transmit and/or receive wireless signals and can include a user equipment (WTRU), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d can be interchangeably referred to as a WTRU.

The communications systems 100 can include a base station 114a and/or a base station 114b. Each of the base stations 114a, 114b can be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b can be a base transceiver station (BTS), a Node-B, an eNode B, a Home Node B, a Home eNode B, a base station, a NR NodeB, a site controller, an access point (AP), a wireless router, and the like. While the base stations 114a, 114b are each depicted as a single element, it will be appreciated that the base stations 114a, 114b can include any number of interconnected base stations and/or network elements.

The base station 114a can be part of the RAN 104/113, which can also include other base stations and/or network elements (not shown), such as a base station controller (BSC), a radio network controller (RNC), relay nodes, etc. The base station 114a and/or the base station 114b can be configured to transmit and/or receive wireless signals on one or more carrier frequencies, which can be referred to as a cell (not shown). These frequencies can be in licensed spectrum, unlicensed spectrum, or a combination of licensed and unlicensed spectrum. A cell can provide coverage for a wireless service to a specific geographical area that can be relatively fixed or that can change over time. The cell can further be divided into cell sectors. For example, the cell associated with the base station 114a can be divided into three sectors. Thus, in one embodiment, the base station 114a can include three transceivers, i.e., one for each sector of the cell. In an embodiment, the base station 114a can employ multiple-input multiple output (MIMO) technology and can utilize multiple transceivers for each sector of the cell. For example, beamforming can be used to transmit and/or receive signals in desired spatial directions.

The base stations 114a, 114b can communicate with one or more of the WTRUs 102a, 102b, 102c, 102d over an air interface 116, which can be any suitable wireless communication link (e.g., radio frequency (RF), microwave, centimeter wave, micrometer wave, infrared (IR), ultraviolet (UV), visible light, etc.). The air interface 116 can be established using any suitable radio access technology (RAT).

More specifically, as noted above, the communications system 100 can be a multiple access system and can employ one or more channel access schemes, such as CDMA, TDMA, FDMA, OFDMA, SC-FDMA, and the like. For example, the base station 114a in the RAN 104/113 and the WTRUs 102a, 102b, 102c can implement a radio technology such as Universal Mobile Telecommunications System (UMTS) Terrestrial Radio Access (UTRA), which can establish the air interface 115/116/117 using wideband CDMA (WCDMA). WCDMA can include communication protocols such as High-Speed Packet Access (HSPA) and/or Evolved HSPA (HSPA+). HSPA can include High-Speed Downlink (DL) Packet Access (HSDPA) and/or High-Speed UL Packet Access (HSUPA).

In an embodiment, the base station 114a and the WTRUs 102a, 102b, 102c can implement a radio technology such as Evolved UMTS Terrestrial Radio Access (E-UTRA), which can establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c can implement a radio technology such as NR Radio Access, which can establish the air interface 116 using New Radio (NR).

In an embodiment, the base station 114a and the WTRUs 102a, 102b, 102c can implement multiple radio access technologies. For example, the base station 114a and the WTRUs 102a, 102b, 102c can implement LTE radio access and NR radio access together, for instance using dual connectivity (DC) principles. Thus, the air interface utilized by WTRUs 102a, 102b, 102c can be characterized by multiple types of radio access technologies and/or transmissions sent to/from multiple types of base stations (e.g., a eNB and a base station).

In other embodiments, the base station 114a and the WTRUs 102a, 102b, 102c can implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A can be a wireless router, Home Node B, Home eNode B, or access point, for example, and can utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d can implement a radio technology such as IEEE 802.11 to establish a wireless local area network (WLAN). In an embodiment, the base station 114b and the WTRUs 102c, 102d can implement a radio technology such as IEEE 802.15 to establish a wireless personal area network (WPAN). In yet another embodiment, the base station 114b and the WTRUs 102c, 102d can utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b can have a direct connection to the Internet 110. Thus, the base station 114b can not be required to access the Internet 110 via the CN 106/115.

The RAN 104/113 can be in communication with the CN 106/115, which can be any type of network configured to provide voice, data, applications, and/or voice over internet protocol (VoIP) services to one or more of the WTRUs 102a, 102b, 102c, 102d. The data can have varying quality of service (QoS) requirements, such as differing throughput requirements, latency requirements, error tolerance requirements, reliability requirements, data throughput requirements, mobility requirements, and the like. The CN 106/115 can provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 can be in direct or indirect communication with other RANs that employ the same RAT as the RAN 104/113 or a different RAT. For example, in addition to being connected to the RAN 104/113, which can be utilizing a NR radio technology, the CN 106/115 can also be in communication with another RAN (not shown) employing a GSM, UMTS, CDMA 2000, WiMAX, E-UTRA, or WiFi radio technology.

The CN 106/115 can also serve as a gateway for the WTRUs 102a, 102b, 102c, 102d to access the PSTN 108, the Internet 110, and/or the other networks 112. The PSTN 108 can include circuit-switched telephone networks that provide plain old telephone service (POTS). The Internet 110 can include a global system of interconnected computer networks and devices that use common communication protocols, such as the transmission control protocol (TCP), user datagram protocol (UDP) and/or the internet protocol (IP) in the TCP/IP internet protocol suite. The networks 112 can include wired and/or wireless communications networks owned and/or operated by other service providers. For example, the networks 112 can include another CN connected to one or more RANs, which can employ the same RAT as the RAN 104/113 or a different RAT.

One or more (e.g., all) of the WTRUs 102a, 102b, 102c, 102d in the communications system 100 can include multi-mode capabilities (e.g., the WTRUs 102a, 102b, 102c, 102d can include multiple transceivers for communicating with different wireless networks over different wireless links). For example, the WTRU 102c shown in FIG. 1A can be configured to communicate with the base station 114a, which can employ a cellular-based radio technology, and with the base station 114b, which can employ an IEEE 802 radio technology.

FIG. 1B is a system diagram illustrating an example WTRU 102. As shown in FIG. 1B, the WTRU 102 can include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 can include any sub-combination of the foregoing elements while remaining includeent with an embodiment.

The processor 118 can be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 can perform signal coding, data processing, power control, input/output processing, and/or any other functionality that enables the WTRU 102 to operate in a wireless environment. The processor 118 can be coupled to the transceiver 120, which can be coupled to the transmit/receive element 122. While FIG. 1B depicts the processor 118 and the transceiver 120 as separate components, it will be appreciated that the processor 118 and the transceiver 120 can be integrated together in an electronic package or chip.

The transmit/receive element 122 can be configured to transmit signals to, or receive signals from, a base station (e.g., the base station 114a) over the air interface 116. For example, in one embodiment, the transmit/receive element 122 can be an antenna configured to transmit and/or receive RF signals. In an embodiment, the transmit/receive element 122 can be an emitter/detector configured to transmit and/or receive IR, UV, or visible light signals, for example. In yet another embodiment, the transmit/receive element 122 can be configured to transmit and/or receive both RF and light signals. It will be appreciated that the transmit/receive element 122 can be configured to transmit and/or receive any combination of wireless signals.

Although the transmit/receive element 122 is depicted in FIG. 1B as a single element, the WTRU 102 can include any number of transmit/receive elements 122. More specifically, the WTRU 102 can employ MIMO technology. Thus, in one embodiment, the WTRU 102 can include two or more transmit/receive elements 122 (e.g., multiple antennas) for transmitting and receiving wireless signals over the air interface 116.

The transceiver 120 can be configured to modulate the signals that are to be transmitted by the transmit/receive element 122 and to demodulate the signals that are received by the transmit/receive element 122. As noted above, the WTRU 102 can have multi-mode capabilities. Thus, the transceiver 120 can include multiple transceivers for enabling the WTRU 102 to communicate via multiple RATs, such as NR and IEEE 802.11, for example.

The processor 118 of the WTRU 102 can be coupled to, and can receive user input data from, the speaker/microphone 124, the keypad 126, and/or the display/touchpad 128 (e.g., a liquid crystal display (LCD) display unit or organic light-emitting diode (OLED) display unit). The processor 118 can also output user data to the speaker/microphone 124, the keypad 126, and/or the display/touchpad 128. In addition, the processor 118 can access information from, and store data in, any type of suitable memory, such as the non-removable memory 130 and/or the removable memory 132. The non-removable memory 130 can include random-access memory (RAM), read-only memory (ROM), a hard disk, or any other type of memory storage device. The removable memory 132 can include a subscriber identity module (SIM) card, a memory stick, a secure digital (SD) memory card, and the like. In other embodiments, the processor 118 can access information from, and store data in, memory that is not physically located on the WTRU 102, such as on a server or a home computer (not shown).

The processor 118 can receive power from the power source 134, and can be configured to distribute and/or control the power to the other components in the WTRU 102. The power source 134 can be any suitable device for powering the WTRU 102. For example, the power source 134 can include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 can also be coupled to the GPS chipset 136, which can be configured to provide location information (e.g., longitude and latitude) regarding the current location of the WTRU 102. In addition to, or in lieu of, the information from the GPS chipset 136, the WTRU 102 can receive location information over the air interface 116 from a base station (e.g., base stations 114a, 114b) and/or determine its location based on the timing of the signals being received from two or more nearby base stations. It will be appreciated that the WTRU 102 can acquire location information by way of any suitable location-determination method while remaining consistent with an embodiment.

The processor 118 can further be coupled to other peripherals 138, which can include one or more software and/or hardware modules that provide additional features, functionality and/or wired or wireless connectivity. For example, the peripherals 138 can include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 can include one or more sensors, the sensors can be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 can include a full duplex radio for which transmission and reception of some or all of the signals (e.g., associated with particular subframes for both the UL (e.g., for transmission) and downlink (e.g., for reception) can be concurrent and/or simultaneous. The full duplex radio can include an interference management unit to reduce and or substantially eliminate self-interference via either hardware (e.g., a choke) or signal processing via a processor (e.g., a separate processor (not shown) or via processor 118). In an embodiment, the WTRU 102 can include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 can employ an E-UTRA radio technology to communicate with the WTRUs 102a, 102b, 102c over the air interface 116. The RAN 104 can also be in communication with the CN 106.

The RAN 104 can include eNode-Bs 160a, 160b, 160c, though it will be appreciated that the RAN 104 can include any number of eNode-Bs while remaining includeent with an embodiment. The eNode-Bs 160a, 160b, 160c can each include one or more transceivers for communicating with the WTRUs 102a, 102b, 102c over the air interface 116. In one embodiment, the eNode-Bs 160a, 160b, 160c can implement MIMO technology. Thus, the eNode-B 160a, for example, can use multiple antennas to transmit wireless signals to, and/or receive wireless signals from, the WTRU 102a.

Each of the eNode-Bs 160a, 160b, 160c can be associated with a particular cell (not shown) and can be configured to handle radio resource management decisions, handover decisions, scheduling of users in the UL and/or DL, and the like. As shown in FIG. 1C, the eNode-Bs 160a, 160b, 160c can communicate with one another over an X2 interface.

The CN 106 shown in FIG. 1C can include a mobility management entity (MME) 162, a serving gateway (SGW) 164, and a packet data network (PDN) gateway (or PGW) 166. While each of the foregoing elements are depicted as part of the CN 106, it will be appreciated that any of these elements can be owned and/or operated by an entity other than the CN operator.

The MME 162 can be connected to each of the eNode-Bs 162a, 162b, 162c in the RAN 104 via an S1 interface and can serve as a control node. For example, the MME 162 can be responsible for authenticating users of the WTRUs 102a, 102b, 102c, bearer activation/deactivation, selecting a particular serving gateway during an initial attach of the WTRUs 102a, 102b, 102c, and the like. The MME 162 can provide a control plane function for switching between the RAN 104 and other RANs (not shown) that employ other radio technologies, such as GSM and/or WCDMA.

The SGW 164 can be connected to each of the eNode Bs 160a, 160b, 160c in the RAN 104 via the S1 interface. The SGW 164 can generally route and forward user data packets to/from the WTRUs 102a, 102b, 102c. The SGW 164 can perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 can be connected to the PGW 166, which can provide the WTRUs 102a, 102b, 102c with access to packet-switched networks, such as the Internet 110, to facilitate communications between the WTRUs 102a, 102b, 102c and IP-enabled devices.

The CN 106 can facilitate communications with other networks. For example, the CN 106 can provide the WTRUs 102a, 102b, 102c with access to circuit-switched networks, such as the PSTN 108, to facilitate communications between the WTRUs 102a, 102b, 102c and traditional land-line communications devices. For example, the CN 106 can include, or can communicate with, an IP gateway (e.g., an IP multimedia subsystem (IMS) server) that serves as an interface between the CN 106 and the PSTN 108. In addition, the CN 106 can provide the WTRUs 102a, 102b, 102c with access to the other networks 112, which can include other wired and/or wireless networks that are owned and/or operated by other service providers.

Although the WTRU is described in FIGS. 1A-1D as a wireless terminal, it is contemplated that in certain representative embodiments that such a terminal can use (e.g., temporarily or permanently) wired communication interfaces with the communication network.

In representative embodiments, the other network 112 can be a WLAN.

A WLAN in Infrastructure Basic Service Set (BSS) mode can have an Access Point (AP) for the BSS and one or more stations (STAs) associated with the AP. The AP can have an access or an interface to a Distribution System (DS) or another type of wired/wireless network that carries traffic in to and/or out of the BSS. Traffic to STAs that originates from outside the BSS can arrive through the AP and can be delivered to the STAs. Traffic originating from STAs to destinations outside the BSS can be sent to the AP to be delivered to respective destinations. Traffic between STAs within the BSS can be sent through the AP, for example, where the source STA can send traffic to the AP and the AP can deliver the traffic to the destination STA. The traffic between STAs within a BSS can be considered and/or referred to as peer-to-peer traffic. The peer-to-peer traffic can be sent between (e.g., directly between) the source and destination STAs with a direct link setup (DLS). In certain representative embodiments, the DLS can use an 802.11e DLS or an 802.11z tunneled DLS (TDLS). A WLAN using an Independent BSS (IBSS) mode can not have an AP, and the STAs (e.g., all of the STAs) within or using the IBSS can communicate directly with each other. The IBSS mode of communication can sometimes be referred to herein as an “ad-hoc” mode of communication.

When using the 802.11ac infrastructure mode of operation or a similar mode of operations, the AP can transmit a beacon on a fixed channel, such as a primary channel. The primary channel can be a fixed width (e.g., 20 MHz wide bandwidth) or a dynamically set width via signaling. The primary channel can be the operating channel of the BSS and can be used by the STAs to establish a connection with the AP. In certain representative embodiments, Carrier Sense Multiple Access with Collision Avoidance (CSMA/CA) can be implemented, for example in in 802.11 systems. For CSMA/CA, the STAs (e.g., every STA), including the AP, can sense the primary channel. If the primary channel is sensed/detected and/or determined to be busy by a particular STA, the particular STA can back off. One STA (e.g., only one station) can transmit at any given time in a given BSS.

High Throughput (HT) STAs can use a 40 MHz wide channel for communication, for example, via a combination of the primary 20 MHz channel with an adjacent or nonadjacent 20 MHz channel to form a 40 MHz wide channel.

Very High Throughput (VHT) STAs can support 20 MHz, 40 MHz, 80 MHz, and/or 160 MHz wide channels. The 40 MHz, and/or 80 MHz, channels can be formed by combining contiguous 20 MHz channels. A 160 MHz channel can be formed by combining 8 contiguous 20 MHz channels, or by combining two non-contiguous 80 MHz channels, which can be referred to as an 80+80 configuration. For the 80+80 configuration, the data, after channel encoding, can be passed through a segment parser that can divide the data into two streams. Inverse Fast Fourier Transform (IFFT) processing, and time domain processing, can be done on each stream separately. The streams can be mapped on to the two 80 MHz channels, and the data can be transmitted by a transmitting STA. At the receiver of the receiving STA, the above described operation for the 80+80 configuration can be reversed, and the combined data can be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah can support Meter Type Control/Machine-Type Communications, such as MTC devices in a macro coverage area. MTC devices can have certain capabilities, for example, limited capabilities including support for (e.g., only support for) certain and/or limited bandwidths. The MTC devices can include a battery with a battery life above a threshold (e.g., to maintain a very long battery life).

WLAN systems, which can support multiple channels, and channel bandwidths, such as 802.11n, 802.11ac, 802.11af, and 802.11ah, include a channel which can be designated as the primary channel. The primary channel can have a bandwidth equal to the largest common operating bandwidth supported by all STAs in the BSS. The bandwidth of the primary channel can be set and/or limited by a STA, from among all STAs in operating in a BSS, which supports the smallest bandwidth operating mode. In the example of 802.11ah, the primary channel can be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings can depend on the status of the primary channel. If the primary channel is busy, for example, due to a STA (which supports only a 1 MHz operating mode), transmitting to the AP, the entire available frequency bands can be considered busy even though a majority of the frequency bands remains idle and can be available.

In the United States, the available frequency bands, which can be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 can employ an NR radio technology to communicate with the WTRUs 102a, 102b, 102c over the air interface 116. The RAN 113 can also be in communication with the CN 115.

The RAN 113 can include base stations 180a, 180b, 180c, though it will be appreciated that the RAN 113 can include any number of base stations while remaining includeent with an embodiment. The base stations 180a, 180b, 180c can each include one or more transceivers for communicating with the WTRUs 102a, 102b, 102c over the air interface 116. In one embodiment, the base stations 180a, 180b, 180c can implement MIMO technology. For example, base stations 180a, 108b can utilize beamforming to transmit signals to and/or receive signals from the base stations 180a, 180b, 180c. Thus, the base station 180a, for example, can use multiple antennas to transmit wireless signals to, and/or receive wireless signals from, the WTRU 102a. In an embodiment, the base stations 180a, 180b, 180c can implement carrier aggregation technology. For example, the base station 180a can transmit multiple component carriers to the WTRU 102a (not shown). A subset of these component carriers can be on unlicensed spectrum while the remaining component carriers can be on licensed spectrum. In an embodiment, the base stations 180a, 180b, 180c can implement Coordinated Multi-Point (COMP) technology. For example, WTRU 102a can receive coordinated transmissions from base station 180a and base station 180b (and/or base station 180c).

The WTRUs 102a, 102b, 102c can communicate with base stations 180a, 180b, 180c using transmissions associated with a scalable numerology. For example, the OFDM symbol spacing and/or OFDM subcarrier spacing can vary for different transmissions, different cells, and/or different portions of the wireless transmission spectrum. The WTRUs 102a, 102b, 102c can communicate with base stations 180a, 180b, 180c using subframe or transmission time intervals (TTIs) of various or scalable lengths (e.g., containing varying number of OFDM symbols and/or lasting varying lengths of absolute time).

The base stations 180a, 180b, 180c can be configured to communicate with the WTRUs 102a, 102b, 102c in a standalone configuration and/or a non-standalone configuration. In the standalone configuration, WTRUs 102a, 102b, 102c can communicate with base stations 180a, 180b, 180c without also accessing other RANs (e.g., such as eNode-Bs 160a, 160b, 160c). In the standalone configuration, WTRUs 102a, 102b, 102c can utilize one or more of base stations 180a, 180b, 180c as a mobility anchor point. In the standalone configuration, WTRUs 102a, 102b, 102c can communicate with base stations 180a, 180b, 180c using signals in an unlicensed band. In a non-standalone configuration WTRUs 102a, 102b, 102c can communicate with/connect to base stations 180a, 180b, 180c while also communicating with/connecting to another RAN such as eNode-Bs 160a, 160b, 160c. For example, WTRUs 102a, 102b, 102c can implement DC principles to communicate with one or more base stations 180a, 180b, 180c and one or more eNode-Bs 160a, 160b, 160c substantially simultaneously. In the non-standalone configuration, eNode-Bs 160a, 160b, 160c can serve as a mobility anchor for WTRUs 102a, 102b, 102c and base stations 180a, 180b, 180c can provide additional coverage and/or throughput for servicing WTRUs 102a, 102b, 102c.

Each of the base stations 180a, 180b, 180c can be associated with a particular cell (not shown) and can be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the base stations 180a, 180b, 180c can communicate with one another over an Xn interface.

The CN 115 shown in FIG. 1D can include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements can be owned and/or operated by an entity other than the CN operator.

The AMF 182a, 182b can be connected to one or more of the base stations 180a, 180b, 180c in the RAN 113 via an N2 interface and can serve as a control node. For example, the AMF 182a, 182b can be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing can be used by the AMF 182a, 182b in order to customize CN support for WTRUs 102a, 102b, 102c based on the types of services being utilized WTRUs 102a, 102b, 102c. For example, different network slices can be established for different use cases such as services relying on ultra-reliable low latency (URLLC) access, services relying on enhanced massive mobile broadband (eMBB) access, services for machine type communication (MTC) access, and/or the like. The AMF 162 can provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b can be connected to an AMF 182a, 182b in the CN 115 via an N11 interface. The SMF 183a, 183b can also be connected to a UPF 184a, 184b in the CN 115 via an N4 interface. The SMF 183a, 183b can select and control the UPF 184a, 184b and configure the routing of traffic through the UPF 184a, 184b. The SMF 183a, 183b can perform other functions, such as managing and allocating WTRU IP address, managing PDU sessions, controlling policy enforcement and QoS, providing downlink data notifications, and the like. A PDU session type can be IP-based, non-IP based, Ethernet-based, and the like.

The UPF 184a, 184b can be connected to one or more of the base stations 180a, 180b, 180c in the RAN 113 via an N3 interface, which can provide the WTRUs 102a, 102b, 102c with access to packet-switched networks, such as the Internet 110, to facilitate communications between the WTRUs 102a, 102b, 102c and IP-enabled devices. The UPF 184, 184b can perform other functions, such as routing and forwarding packets, enforcing user plane policies, supporting multi-homed PDU sessions, handling user plane QoS, buffering downlink packets, providing mobility anchoring, and the like.

The CN 115 can facilitate communications with other networks. For example, the CN 115 can include, or can communicate with, an IP gateway (e.g., an IP multimedia subsystem (IMS) server) that serves as an interface between the CN 115 and the PSTN 108. In addition, the CN 115 can provide the WTRUs 102a, 102b, 102c with access to the other networks 112, which can include other wired and/or wireless networks that are owned and/or operated by other service providers. In one embodiment, the WTRUs 102a, 102b, 102c can be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, base station 180a-c, AMF 182a-b, UPF 184a-b, SMF 183a-b, DN 185a-b, and/or any other device(s) described herein, can be performed by one or more emulation devices (not shown). The emulation devices can be one or more devices configured to emulate one or more, or all, of the functions described herein. For example, the emulation devices can be used to test other devices and/or to simulate network and/or WTRU functions.

The emulation devices can be designed to implement one or more tests of other devices in a lab environment and/or in an operator network environment. For example, the one or more emulation devices can perform the one or more, or all, functions while being fully or partially implemented and/or deployed as part of a wired and/or wireless communication network in order to test other devices within the communication network. The one or more emulation devices can perform the one or more, or all, functions while being temporarily implemented/deployed as part of a wired and/or wireless communication network. The emulation device can be directly coupled to another device for purposes of testing and/or can perform testing using over-the-air wireless communications.

The one or more emulation devices can perform the one or more, including all, functions while not being implemented/deployed as part of a wired and/or wireless communication network. For example, the emulation devices can be utilized in a testing scenario in a testing laboratory and/or a non-deployed (e.g., testing) wired and/or wireless communication network in order to implement testing of one or more components. The one or more emulation devices can be test equipment. Direct RF coupling and/or wireless communications via RF circuitry (e.g., which can include one or more antennas) can be used by the emulation devices to transmit and/or receive data.

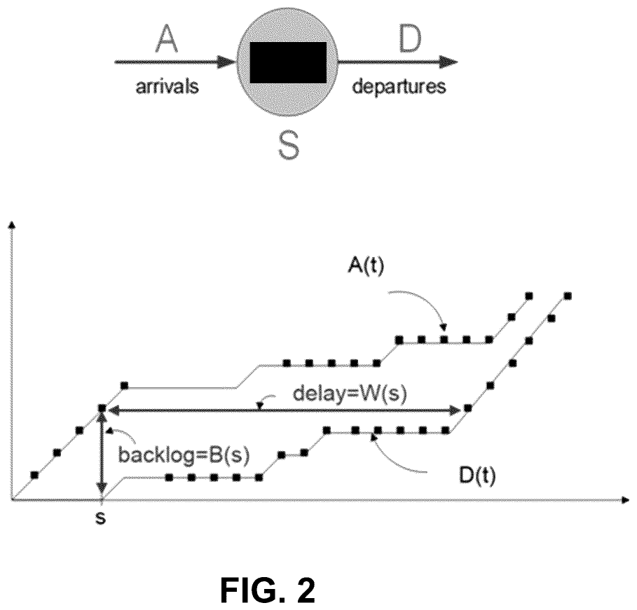

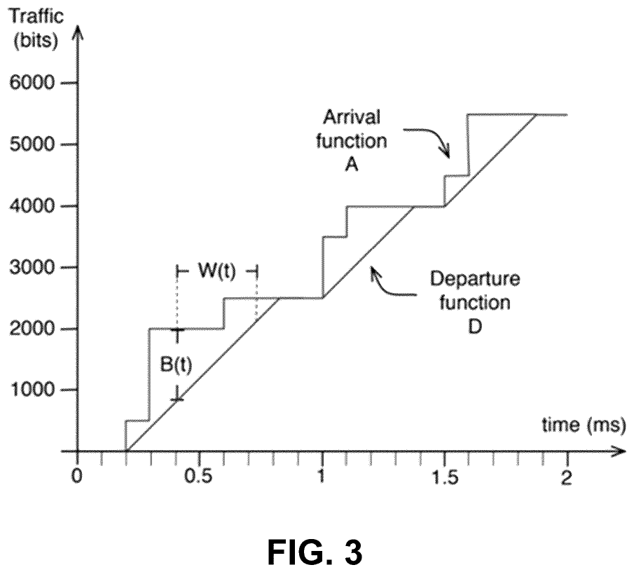

A traffic scheduling regulator may be used (e.g., in the uplink) to characterize traffic transmission rates at a WTRU. The traffic scheduling regulator may determine the bounds (e.g., worst-case bounds) on delay and/or backlog in the WTRU's buffer. FIG. 2 illustrates an example of a traffic scheduling regulator S, where A may represent the cumulative arrival function of traffic for a given flow to the WTRU's buffer and D may represent the transmission departure function from the WTRU's buffer to a scheduled grant. FIG. 3 illustrates examples of UL traffic arrival and departure functions at a WTRU buffer

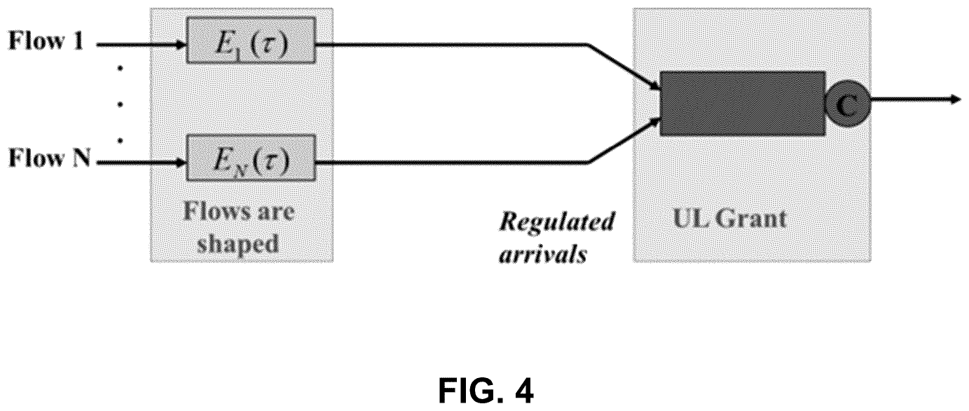

A (e.g., each) traffic flow competing for resources on a given uplink grant may be shaped by an envelope “E” such that E(t−s)>=A(s, t), as illustrated in FIG. 4. A traffic shaper (e.g., as a scheduling implementation) may be used to ensure that departing UL traffic comply with a given traffic envelope, and/or to buffer non-compliant traffic.

There may be various reasons for shaping traffic for a given flow. For example, an operator may want to ensure that traffic from and to a given data flow comply with a subscribed data rate. As another example, in video streaming over a cellular network, the rate of video streams may be matched to the available capacity of an RF link. This kind of regulation may be referred to as traffic shaping or smoothing. With the regulation, transmitted traffic may be classified as shaped (e.g., compliant) traffic and non-shaped traffic. The shaped/compliant traffic may satisfy a given traffic specification (e.g., traffic served within the bounds of a traffic departure envelope). The non-shaped traffic may be allocated to a grant and may exceed a traffic shaper (e.g., based on a water level in a traffic shaping bucket). The non-shaped traffic may be giving lower or best-effort priority and may be buffered if not transmitted.

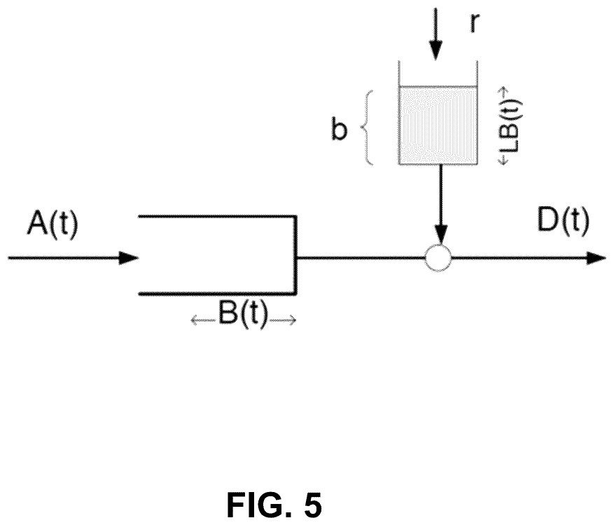

In examples, a traffic shaping regulator for a given flow may use a Leaky bucket algorithm, for example, as illustrated in FIG. 5, where a bucket may be filled with fluid up to an indicated level, and LB(t) may indicate the filling level of the bucket at time t. Using the leaky bucket algorithm, an envelope may have the form of E(t)=b+r·t, where b may represent a maximum burst size (e.g., which may be useful for bursty traffic), r may represent a long-term traffic rate (e.g., which may be set as the statistical average of traffic transmission rate requirements), r·t may represent a multiplication of r and t. The bucket may be initially set to LB(0)=b, which may be referred to as a full bucket. The bucket may be filled with fluid at a rate r (e.g., nothing may be added when the bucket is full). In examples, the content of the bucket LB(t) may represent the maximum amount of traffic that may be transmitted at the time of transport block (TB) construction (e.g., assuming there is sufficient space). For each transmission of an SDU, the content of the leaky bucket may be reduced by the size of the SDU. When LB(t)=0, the bucket may be empty, and no traffic may be transmitted. Traffic arrivals to an empty bucket may be stored in a buffer and traffic in the buffer may be transmitted at the filling rate r.

Logical channel prioritization (LCP) for UL TB construction may be an example of a leaky bucket implementation. For example, a bucket “Bj” for LCP may represent a leaky bucket, and traffic may be enforced to comply with a long-term rate (PBR) and a bucket size (PBR×BSD). The LCP leaky bucket may use an envelope of the form E(s)=b+PBR·s, where b may have a value of 0 and PBR may represent a long-term traffic rate (e.g., set as the statistical average of traffic transmission rate requirements). As such, a bucket in LCP may use an envelope of the form: E(s)=PBR·s.

In examples, when assembling a transport block for UL transmission using LCP, a WTRU may serve data from one or more logical channels (LCHs) using the following principles. The WTRU may perform the LCP in multiple (e.g., three) rounds. In a first round (e.g., round 1 or step 0), the WTRU may select the logical channels that may be applicable for transmission on an associated uplink grant, where the selection may depend on configured logical channel selection restrictions that may be configured via RRC signaling. These logical channels may contend for resource allocation in the following rounds of the LCP procedure. In a second round (e.g., round 2 or step 1), data from the selected logical channels may be taken up to a prioritized bit rate (PBR) in a decreasing logical channel (LCH) priority order. In examples, the data capacity associated with the PBR may exceed the available amount of data associated with an LCH for transmission in a given TTI (e.g., which may be referred to a “token bucket”), for example, to avoid unnecessary radio link control (RLC) segmentation. In a third round, (e.g., round 3 or step 2 or 3), the remaining buffered data from the selected logical channels exceeding what has been allocated in the second round may be allocated in a decreasing LCH priority order to fill the remaining resources.

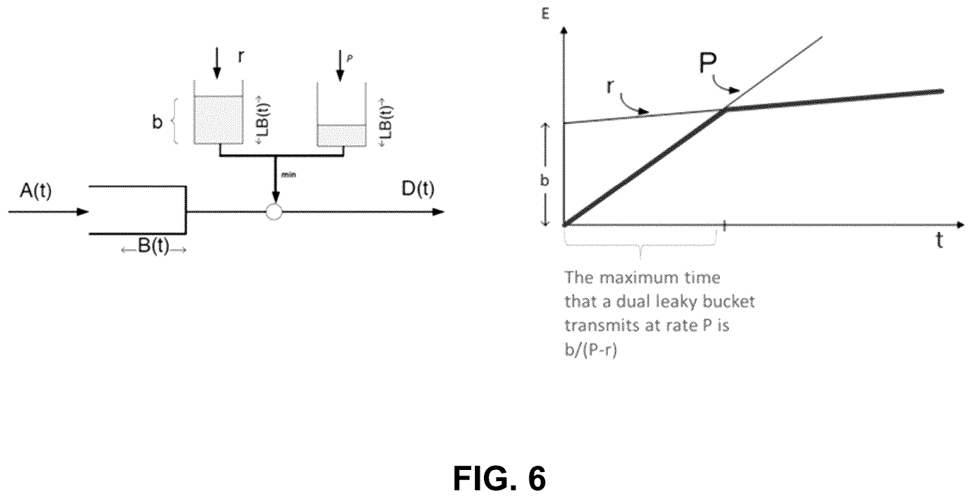

A variation of the leaky bucket may be a dual leaky bucket or a peak-rate constrained leaky bucket. A traffic regulator using such a variation may enforce an envelope of the form E(t)=min {Pt; b+rt}, as illustrated in FIG. 6. The dual leaky bucket may provide the ability to regulate a traffic rate on a short term (e.g., via parameters P and b) and/or a long term (e.g., via parameter r), and may provide flexibility to handle complex arrival functions. r may be configured as the average rate of a traffic arrival process and may thus represent a long-term average traffic rate. P>r may represent a max or peak data rate, which may bound the maximum short term transmission rate at which traffic may depart the traffic regulator.

The peak rate P may be determined as a function of network resources, for example, if the network resources impose constraints on the maximum rate at which traffic may be processed or transmitted (e.g., a maximum data burst volume (MDBV) within a time period). The peak rate P may be determined as a function of traffic (e.g., for a transmission of compressed/coded video data traffic). For example, a video encoder may require that a video frame be fully transmitted before the arrival of a next frame from an application. In this case, the rate P may be given by the size of the largest video frame (e.g., in terms of bytes) multiplied by a frame rate (e.g., 50 frames per second). In another example, a gated transmissions may be defined, where if PDU x within a protocol data unit (PDU) set succeeds, further PDUs in the set (e.g., with index>x) may be transmitted, and if PDU x doesn't succeed, further PDU transmissions from the set may be halted. In such an example, P may be set to a value to satisfy the transmission of PDU x in one grant.

A user plane interface may be designed to transmit best effort data with a minimum and/or a guaranteed bit rate, and not much beyond those rates. A data plane interface (e.g., an L2 interface) may be designed to improve wireless communications with respect to one or more of the following areas. A first area may be computational efficiency. This is because L2 processing may scale linearly with a packet rate. As the packet rate increases, processing demands and/or power consumption may also increase, creating overhead challenges for a network and/or a WTRU. Layering of L2 protocols may create an overly hierarchical structure that may lead to manufactured latencies and/or increased computational complexity.

A second area for improvement may be related to QoS, latency and/or reliability. An L2 interface may support variable QoS requirements, low latency, and/or high reliability (e.g., for extreme applications such as extended reality (XR), virtual reality (VR), augmented reality (AR), high reliability low latency communication (HRLLC), enhanced ultra reliable low latency communication (eURLLC), etc.). In some example communication systems, retransmissions may be duplicated in multiple layers. As such, retransmissions at a higher layer (e.g., at an RLC layer) may be too slow to satisfy latency sensitive applications (e.g., XR applications). The retransmissions may also be quite rigid (e.g., the retransmitted data may be exactly the same, the TB sizes used may be same, the carriers used may be same, etc.). In some examples, QoS (quality of service) attributes may be assigned to each data set or channel (e.g., the QoS attributes may include priority, PBR, PDB, PER, BLER, PDSB, dependencies to other sets, strict delay, energy consumption, complexity metrics, etc.). An L2 interface may allow for elastic QoE (quality of experence) level varying (e.g., between a min data rate/GBR, and a max data rate), for example, upon meeting QoS requirements. The QoE may meet a minimum requirement. For example, a WTRU may start a transmission of data with a given QoE level that may be high. As the WTRU moves out of coverage, experiences cell congestion, or when a data rate drops, the WTRU may reduce the QoE level or reduce the number of data packet sets that may be transmitted. For example, if there are multiple streams or a multi-modal stream, the WTRU may drop a stream that may not be necessary to meet the minimum QoE level while still maintaining a QoS level.

A third area for improvement may be related to the support for different data types. In some example communication systems, signaling radio bearer (SRB) and data radio bearer (DRB) data may be differentiated, and treatment of UP data QoS may be controlled by a QoS flow to DRB mapping. Once mapped to a DRB, packet treatment may be done semi-statically. With new types of applications (e.g., AI/ML, XR, sensing, volumetric video, etc.), new data types may be introduced, potentially within a QoS flow, and differentiated data treatment (e.g., for important/systematic packets) may not be supported for a QoS flow. Further, data sets may be classified by type into control, data, sensory, Al/ML data, etc. As such, an L2 interface may be designed to avoid unnecessary data transmission, and/or to handle QoS/QoE dependencies between different data types (e.g., user plane data, control plane data, system data, etc.) and/or dependencies between data of the same type.

A fourth area for improvement may be related to WTRU and/or network power consumption. An L2 protocol may be designed to enable WTRU and/or network power savings. DRBs may not be elastic in terms of resource allocation and mapping across cells and cell groups, and therefore the L2 interface may be designed to support timely WTRU reachability, WTRU processing chain power consumption, and/or balancing of network and WTRU energy consumption. This way, a PDU may be transmitted or received in a more dynamic manner, for example, without rigid restrictions on DRBs, carriers, or cell groups.

A fifth area for improvement may be related to scheduling, capacity and/or congestion. This may be because a configured grant may be responsive to delay bounds, but may cause signaling overhead. Further, transmissions on dynamic grants (e.g., following a scheduling report (SR) or a buffer status report (BSR) may incur delays, and LCP may be based on leaky bucket uplink traffic shaping, without considering inter-packet associations, latency bounds, or congestion.

A sixth area for improvement may be related to application layer awareness. This may be because some communication systems may not support differentiated treatment for more important packets (e.g., the relevance of the packets may vary over time or over other control receptions such as within a bearer), and different applications may generate packets that have different importance. Existing L2 protocols may not have evolved with new application layer transport protocols (e.g., such as a Quick UDP Internet Connection (QUIC) developed for faster, more reliable, and more efficient data transfer). When referred to herein, awareness may include a RAN's awareness of application QoS and/or QoE metrics/data (e.g., events, important/relevant data, etc.), and/or an application's awareness of dynamic conditions at the RAN (e.g., radio conditions, congestions, cell loads, etc.). In examples, an application may adjust the rate of a packet set and may not change the underlying QoE level (e.g., when a video rate is decreased by the application). In these examples, a WTRU may or may not be aware of what the application layer is doing (e.g., the WTRU may have no awareness in a first case, but may have awareness in a second case). The awareness referred to herein may also include awareness of application flow dependencies, synchronization, and/or other system data (e.g., sensory, AI/ML, control plane (CP) triggered events such as handover, etc.).

A transport block (TB) may be constructed (e.g., filled with data) by taking a WTRU's channel conditions, power headroom, and/or reliability requirements into account. An LCP procedure may consider the transmit power, channel conditions, and/or energy consumption at a network node and/or a WTRU. For example, while a network device may receive reports of a WTRU's power headroom, the power headroom may have changed by the time the WTRU finishes constructing a TB (e.g., the WTRU may be in worse coverage conditions compared to the time the WTRU sent the power headroom report (PHR). In other words, the PHR sent by the WTRU may be applicable only to already-constructed TBs and not to a TB currently being constructed (e.g., there may be a time or scheduling delay between PHR reporting and TB transmission during which channel conditions and/or the power headroom can change, for example, due to fast fading). In some communication systems, the WTRU may allocate as many bits as specified by a transport block size (TBS), regardless of the actual or instantaneous power headroom at the time the transport block is constructed/transmitted and/or without considering whether the inclusion of additional lower priority data in the transport block may impact higher priority data in the TB. In systems that support dual connectivity, it may be even more difficult to predict power headroom when scheduling is done from one node and grants are issued for one or both legs. In these systems, a WTRU may report the power headroom for both legs (e.g., in the same MAC control element (CE)) and thus there may be a reporting delay between the nodes over a network interface. Further, the WTRU may compute a virtual power headroom for the non-scheduling node, so the reported headroom for that node may not be accurate. Thus, headroom reporting in these systems may require more coordination between two base stations (e.g., gNBs), and the issue may be more pronounced for simultaneous transmissions (e.g., transmissions over a split bearer, transmissions based on duplication, or transmissions on two grants simultaneously).

Logical channel prioritization (LCP) in some systems described herein may consume a lot of power, at least from a WTRU perspective (e.g., at a power efficient state, the WTRU may consume more power than needed running an LCP procedure). From a network perspective, the WTRU may be constructing a transport block regardless of the blind decoding energy at the network and without considering the transmit power per data bit included in the transport block.

To improve the performance of these systems, it may be desirable to use a variable size TB and/or varied power allocation per data/information bit. In examples, data allocation or data multiplexing (e.g., in a TB and/or based on a grant) may be performed by taking the transmission power (Tx power) of a WTRU into account. For instance, the WTRU may be configured to allocate resources provided by an uplink (UL) transmission grant at a sub-TB level (e.g., to a subset of physical resource blocks (PRBs) associated with the TB) based on criteria associated with the Tx power of the WTRU. The WTRU may do so, for example, to satisfy a Tx power per data bit metric, by manipulating parts of the TB such that the parts consume zero Tx power (e.g., by dropping PRB(s) associated with those parts of the TB from a PUSCH transmission), by allocating data into a TB until reaching a minimum Tx power per bit (or per PRB) threshold, or until the power headroom of the WTRU falls below a threshold value. In examples, the WTRU may be configured with one or more sub-TB unit sizes (which may also be referred to herein as data allocation step sizes) for allocating data into a TB (e.g., for constructing the TB). For instance, upon receiving an uplink grant, the WTRU may allocate data (e.g., multiplex data from different logical channels) into a TB until a condition (e.g., a threshold condition) is met or satisfied (e.g., until the power headroom of the WTRU becomes less than a threshold or while the power headroom is above the threshold). The WTRU may apply this data allocation technique in step2 or round 2 of an LCP procedure (e.g., as described above), for example. The WTRU may use this data allocation technique for a subset of LCHs or QoS classes, for example. The WTRU may treat unallocated bits within the grant (e.g., when the aforementioned condition is no longer satisfied) by manipulating (e.g., padding) parts of the TB such that they may consume zero tx power in an OFDM transmitter (e.g., the WTRU may drop PRBs associated with the unallocated bits from the transmission of the TB), thus increasing the power spectral density (PSD) of the TB.

When using the technique described above, the WTRU may granularize bit allocation in units of PUSCH bits/PRB. The WTRU may also perform the data allocation based on other criteria or conditions such as, for example, tx power per data bit, tx power per information bit (mW/bit) (e.g., an information bit may include information other than data such as control information), PSD (mW/Hz), or tx power per PRB (mW/PRB). For example, the WTRU may keep allocating or multiplexing data into a TB until a Tx power per data or information bit reaches (e.g., falls below) a threshold value (e.g., this may indicate that a max power has been reached). The Tx power per data or information bit may be calculated by dividing the transmission power of the WTRU by the number of data or information bits allocated into the TB.

In examples, the WTRU may send an indication (e.g., as part of a TB header or sub-header, via uplink control information (UCI), in a MAC CE, or via a demodulation reference signal (DMRS)) to a network device (e.g., a base station) to indicate that sub-TB data allocation has been performed and/or the sub-TB unit size used for the allocation.

In addition to the tx power related criteria or conditions described herein, the WTRU may perform the sub-TB data allocation based on a channel condition and/or changes to the channel condition (e.g., due to movements or mobility events of the WTRU, based on certain measurements falling below or rising above a threshold value, etc.). Doing so may improve the likelihood of success for re-transmissions (e.g., if a TBS is larger than a threshold value).

The WTRU may perform the sub-TB data allocation based on a type or priority of the data to be transmitted (e.g., based on criticality of the data, QoS class of the data, latency/reliability/type of the data, control info, MAC CEs to be transmitted, etc.). For example, the WTRU may apply the tx power based data allocation technique described herein only for data of certain LCH(s) or data flow(s), data of certain priority (e.g., above a threshold), data of certain QoE level or QoS class, for control information (e.g., UCI or a MAC CE) that may need to be transmitted (e.g., if the control information has higher priority than data). As another example, the WTRU may apply the tx power based data allocation technique described herein only for certain TB sizes (e.g., if the TBS is larger than a threshold), only if a power headroom is within certain range (e.g., if the PH is smaller than a threshold), only if the network and/or WTRU is in a certain energy state (e.g., the WTRU may allocate additional non-compliant data bits if the QoS class/priority/delay for those data bits is of a certain value, such as, for example, during stage 2 of an LCP). As yet another example, the WTRU may apply the tx power based data allocation technique described herein if the scheduling information associated with an uplink grant has certain properties, or based on an indication included in DCI that schedules the uplink grant.

In examples, a WTRU may receive multiple grants, which may overlap in the time/frequency domain, with the same or different TBS sizes and/or MCSes (e.g., these grants may be modelled as multiple grants derived from a single signaled grant). The WTRU may be configured with one or more scaling factors with which the WTRU may derive a lower modulation and control scheme (MCS) from a signaled MCS (the scaling factors may also be pre-configured or fixed in the WTRU based on specifications). The WTRU may receive other grant parameters such as, for example, a number of repetitions, a number of MIMO layers, a number of slots, a number of PRBs, etc.

Out of the received grants, the WTRU may select a grant that meets certain conditions. For example, the WTRU may select a grant if the use of that grant may keep the power headroom of the WTRU above a threshold. The WTRU may also select a grant based on other conditions or criteria described herein for sub-TB data allocation including, for example, tx power per data bit or information bit (mW/bit), PSD (mW/Hz), or tx power per PRB (mW/PRB).

In examples, the WTRU may receive from the network a grant with multiple MCS/TBS values (e.g., instead of changing PRBs) and the WTRU may select a MCS and keep the same PRBs based on the MCS value that may keep the power headroom of the WTRU above a threshold. The WTRU may perform rate matching and/or data multiplexing based on the selected MCS.

In examples, a WTRU may be configured to perform traffic shaping based on a power headroom (e.g., based on a UL power headroom). For example, the WTRU may allocate data based on a grant up to a signaled minimum transport block size (minTBS) associated to the grant. Beyond this minTBS, the WTRU may allocate additional data only if the power headroom of the WTRU remains above a threshold. The WTRU may receive an uplink grant along with an associated “minTBS” value to shape data allocation from all LCHs in the TB for a given reported power headroom. The WTRU may allocate data from LCHs based on certain rules (e.g., higher priority first, up to Bj/PBR in step 1 of an LCP procedure as described herein) until minTBS bits/minPRBs are allocated on the grant. For the remaining space in the grant beyond minTBS, the WTRU may multiplex data on the grant while the power headroom of the WTRU is above a threshold and/or based on whether or not other conditions for sub-TBS allocation are met. The WTRU may treat unallocated portions of the grant by padding parts of the TB so that those parts do not consume transmission power (e.g., the WTRU may drop PRBs associated with the unallocated portions of the grant from transmission). The WTRU may granularize bit allocation in units of PUSCH bits/PRB or MCS steps. For example, the WTRU may allocate up to a TBS for a first MCS (e.g., represented by TBS (MCS1), a TBS for a second MCS (e.g., represented by TBS (MCS2)), a TBS for a third MCS (e.g., represented by TBS (MCS3), etc., where TBS (MCS1)<TBS (MCS2)<TBS (MCS3). The WTRU may omit a power headroom reporting (PHR) MAC CE if the power headroom reaches a certain threshold (e.g., as an implicit way for up/down PH step reporting) and/or if a certain number of padding bits are added. The WTRU may skip an uplink grant and/or transmit a UCI (e.g., a UCI indicating an unused transmission occasion (UTO)) if minTBS number of bits cannot be allocated without having the power headroom dropping below a threshold.

As will be described in greater detail below, a network device may acquire knowledge about the selected number of PRBs/TBS used for a transmission or a grant, for example, based on reporting by the WTRU. The network device may differentiate a PRB with no allocation from a PRB allocated but having frequency selective fading. The network device may perform soft combining (e.g., HARQ soft combining) if an initial TBS is not known by the network device with certainty.

When referred to herein, a channel condition may include any condition relating to the state of a radio or channel, which may be determined by a WTRU based on measurements including, for example, L1/SINR/RSRP, CQI/MCS, channel occupancy, RSSI, power headroom, exposure headroom, L3/mobility-based measurements (e.g. RSRP, RSRQ, or s-measure), RLM state, and/or channel availability in an unlicensed spectrum (e.g., channel availability or occupancy may be determined based on an LBT procedure or whether the channel has experienced a consistent LBT failure).

When referred to herein, uplink control information (UCI) may include CSI, HARQ feedback for one or more HARQ processes, a scheduling request (SR), a link recovery request (LRR), CG-UCI and/or other control information bits that may be transmitted on the PUCCH or PUSCH.

When referred to herein, a gated traffic data flow may be defined as a data set, which may include a set of “gating PDUs” and/or non-gated PDUs. The transmission of a gating PDU may enable the transmission of non-gating PDUs. If PDU x arrives every y ms and is a gating systematic PDU that enables a gated transmission, PDU x+1 may not be transmitted if PDU x is not transmitted or if PDU x is not deemed to have been transmitted successfully (e.g., if the transmission of PDU x is not acknowledged). In examples, if PDU x is received or transmitted at time instance t, PDUs between t and t+y may not be transmitted unless PDU x is transmitted (e.g., transmitted successfully).

In examples involving video traffic with systematic frames, some video applications may not benefit from the transmission of frames following a systematic frame, as a picture may not be complete without it (e.g., the systematic frame should be fully transmitted before the transmission of subsequent frames). For such systematic frames, a WTRU may increase or reinitialize a bucket with values (e.g., values for a maximum burst size b and/or a long-term traffic rate r) to accommodate the scheduling of such PDUs (e.g., the WTRU may select a set of parameters associated with higher QoE transmissions). For other PDUs, the WTRU may select lower values for the bucket related parameters (e.g., for b and/or r describe above).

When referred to herein, scheduling information (e.g., an uplink grant or a downlink assignment) may include at least one of the following: a frequency allocation, an aspect of time allocation such as a time instance or/and a time duration, a priority, a modulation and coding scheme (MCS), a transport block size, a number of spatial layers, a number of transport blocks to be carried, a TCI state or SRI, a number of repetitions, or whether a grant is a configured grant type 1 (e.g., a WTRU may immediately using such configured UL resources after receiving configuration information), type 2 (e.g., a WTRU may wait until an explicit indication such as a MAC CE before using such configured UL resources), or a dynamic grant.

When referred to herein, an indication or DCI indication may include at least one of the following: an explicit indication by a DCI field or by an RNTI used to mask the CRC of a PDCCH transmission, an implicit indication by a property such as a DCI format, a DCI size, a coreset or search space, an aggregation level, an identity of a control channel resource (e.g., the index of a CCE) for a DCI (e.g., the mapping between a property and a value may be signaled by RRC or a MAC CE), or an explicit indication by a MAC CE.

When used herein, “a,” “an” or similar phrases may be interpreted as “one or more” or “at least one.” Any term that ends with the suffix “(s)” may be interpreted as “one or more” or “at least one.” The symbol “/” (e.g., forward slash) may be used herein to represent “and/or” (e.g., “A/B” may mean “A and/or B”).

A traffic shaper may refer to a scheduling implementation for ensuring that departing UL traffic comply with a given traffic envelope and/or for buffering non-compliant traffic. Example techniques for shaping traffic may include Leaky bucket and dual leaky bucket, with shaping exceptions (e.g., when some conditions are met). There may be multiple Leaky bucket or dual leaky bucket based traffic shapers, one or more of which may be applicable for a given time or grant. When more than one traffic shaper is applicable, the minimum shaping water level of them may be taken as an overall limit.

Examples of traffic shapers may include a maximum burst size shaper (e.g., E=burst size), a deterministic shaper for periodic traffic (e.g., E=A (period)/period), or a time variant shaper, which may be enabled by receiving control shaping parameters via network signaling (e.g., a leaky bucket with dynamically signaled shaping parameters such as the r, b, P, and/or BSD described herein).

Examples of traffic shaping techniques may include shortest remaining time first among buffered data units applicable for a grant, highest static priority first (e.g., highest QoS class) among buffered data units applicable for a grant, first in first out among buffered data units applicable for a grant, or no traffic shaping (e.g., a data flow may not be limited or may be limited only to the size of a grant).

A WTRU may maintain a UL traffic shaping bucket (e.g., represented by Bj) for a (e.g., each) data flow, for a (e.g., each) QoS class, or for a (e.g., each) UL traffic shaping envelope. When serving buffered data from a given flow and/or when allocating UL resources in a grant (e.g., bit allocation in a TB), the WTRU may decrease the bucket by the value of the served buffered bits. The water level in the bucket (e.g., Bj) may be negative at some time, possibly due to exceptions (e.g., when using a non-default envelope or when serving data from data untis from a given QoS class). For a given grant, the WTRU may serve buffered data to the grant from each flow up to the water shaping level (e.g., Bj), for example, at least in a first allocation step/round. In one or more subsequent rounds, the WTRU may allocate remaining resources in the grant according to the same envelope or a different envelope, or without traffic shaping at all. The water level (e.g., Bj) may be decreased in the first and/or the subsequent round(s) of resource allocation.

For a given data flow for which the WTRU may maintain a shaping bucket, if the WTRU changes the shaping envelope for a subset of data units, the WTRU may update the bucket as follows. The water level (Bj) may be set to (Bj+the fill rate of an applicable envelope “r” multiplied by the time since the bucket was last updated). The WTRU may fill the bucket with the value “b” of the applicable envelope. The WTRU may assume an updated bucket size of (BSD*r) while the applicable envelope is used for a given data unit.

A network device may acquire knowledge of shaping parameters and/or envelopes. For example, if the WTRU autonomously changes a shaping parameter, the WTRU may notify a serving cell about the change (e.g., as part of assistance info or a MAC CE).

In the example data plane architecture framework illustrated in FIG. 6, an application may provide one or more IP flows for transmission over a medium. One or more (e.g., each) of the IP flows (e.g., which may be associated with respective PDU sessions) may go through a transport layer protocol (e.g., TCP/IP, QUIC, RTP, MOC, etc) and/or a RAN, which may map the IP flow to a RAN data flow or a RAN data set. For a (e.g., each) RAN data flow, the core network may attach some QoS requirements, QoS metrics, and/or a range of QoE metrics.

A RAN data flow may represent a logical association between data packets and/or units, which may originate from the same IP flow. Such association may be based on the data units being associated to the same IP flow, the same application flow, or having the same association packet marked by the core network or an application. Some RAN data flows may not originate from a user application, but rather from a control plane (e.g., control data, RAN signaling, RAN configurations, etc.), from an intelligence plane (e.g., data collected from Al/ML services), a computing plane (e.g., used for native computing for computing services), a system plane (e.g., data originating within the RAN due to sensing or positioning services), and/or a security plane.

A WTRU may assign a QoS class to a (e.g., each) data unit within a RAN data flow for purposes of characterizing how the data may be transmitted. A data protocol plane may include a data unit classification function for QoS/QoE marking throughout a protocol chain. The QoS/QoE class may be determined according to one or more configured or predefined rules. The QoS/QoE class may be used in various layers within the data plane protocol chain for achieving a certain QoS requirement or a QoE level. The QoS/QoE class may be indicated as part of a protocol layer header. A (e.g., each) QoS class may be associated with a QoS treatment profile in the RAN, which may be configured semi-statically. A (e.g., each) QoS treatment profile may include a number of parameters to control the RAN treatment of data transmissions/receptions, and/or a number of metrics to achieve the QoE level for a given layer in the protocol chain. A (e.g., each) QoS class or QoS treatment profile may be associated and/or configured with a priority index, an importance level, a delay bound, a reliability level, a guaranteed bit rate, a maximum bit rate, and/or a maximum packet loss rate.

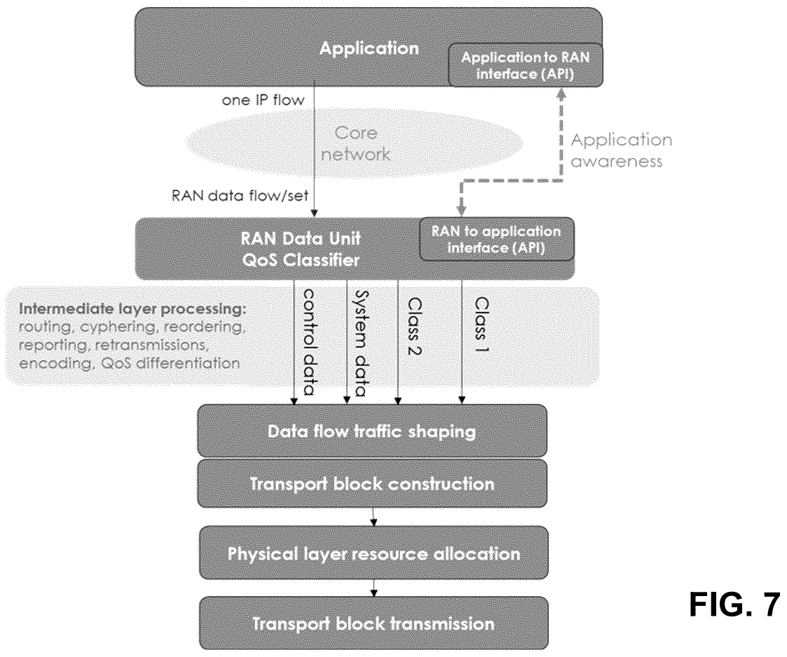

FIG. 7 illustrates an example of a data plane.

A WTRU may classify UL data units (e.g., packets within a data flow, SDUs, or PDUs within a PDU set) on a dynamic basis, where a data unit may be assigned with a QoS class if it meets one or more conditions. Once a condition for QoS classification is met, the WTRU may assign a certain QoS class value to a given data unit, which may or may not be the default QoS class. The WTRU may be configured with a default QoS class, which may be preconfigured (e.g., semi-statically) for a whole data flow. If no special classification conditions are met, the WTRU may classify a data unit from a data flow with the configured default QoS class for the data flow. The WTRU may be configured or predefined with one or more non-default QoS classes, where there may be a mapping between a given non-default QoS class and a condition for QoS classification. Once the condition is met, the WTRU may associate a data unit with the non-default QoS class.

A condition for QoS classification may include one or more of the following. The condition may be based on a packet priority such as the possibility of transmission/inclusion of buffered data from a subset of PDUs within a PDU set, where such PDUs may be configured or predetermined to be of a higher priority, a lower delay bound, or a high QoS treatment profile compared to other PDUs within the set. For example, if a data unit is of a higher priority, the WTRU may associate the data unit with a first QoS class. If the data unit is of a lower priority, the WTRU may associate the data unit with a second QoS class.

The condition for QoS classification may be based on packet importance such as the possibility of transmission/inclusion of buffered data from a subset of PDUs within a PDU set, where such PDUs may be configured or predetermined to be of higher importance compared to other PDUs within the set. The importance value may be obtained based on an indication from a network packet profile, an application interface, or service characteristics (e.g., the period of a packet or the type of packets). For example, if a data unit is of a higher importance, the WTRU may associate the data unit with a first QoS class. If the data unit is of a lower importance, the WTRU may associate the data unit with a second QoS class.

The condition for QoS classification may be based on a packet delay budget such as the possibility of transmission/inclusion of buffered data from a subset of PDUs within a PDU set, where the remaining time may be until the delay budget for a PDU, or an underlying application, becomes less than a threshold. For example, if such a delay budget is less than a threshold, the WTRU may associate the data unit with a certain QoS class.

The condition for QoS classification may be based on a data type such as whether a specific type of data (e.g., AI/ML, XR, sensing, volumetric video, etc.) is included. For example, for a data unit containing AL/ML data, the WTRU may associate the data unit with a first QoS class. For a data unit containing sensing data, the WTRU may associate the data unit with a second QoS class.

The condition for QoS classification may be based on the reception of an indication from an application or a RAN-application interface (API). For example, the application may indicate that a differentiated QoS class may be associated with a given data unit. The indication may indicate the QoS class and/or an identifier associated with it. The WTRU may be configured with a given non-default QoS class to apply to a data unit if an indication (e.g., a flag) is received from the API for the data unit. For example, upon reception of an indication from a higher layer (e.g., from an application) that a packet may be prioritized ahead of other buffered packets in the queue for a data flow, the WTRU may associate a different QoS (e.g., a non-default QoS) class to the data unit.

The condition for QoS classification may be based on the reception of an indication from the network overriding a configured default QoS class for one or more data flows. The Indication may include a given QoS class to apply, possibly for a period of time. Such an indication may be determined based on scheduling information or other information included in a DCI.

The condition for QoS classification may be based on the reception of an indication for a given grant. For example, a DCI may indicate a QoS class and that only data associated with the QoS class may be multiplexed. As another example, the WTRU may multiplex data on a grant and treat a whole TB as data with a signaled QoS class (e.g., in lower layers). Such an indication may be determined based on scheduling information or other information included in the DCI.

The condition for QoS classification may be based on whether the concerned data is from a gating data set. For example, a WTRU may associate a given non-default QoS class with a gating data unit.

The condition for QoS classification may be based on dependent data or data sets. For example, for a data unit on which other units may depend (e.g., an FEC source packet, a video defining frame such as an I-frame, or a gating data unit), a WTRU may assign a non-default (e.g., prioritized) QoS class to the data unit. For dependent, duplicated, or redundant data units, the WTRU may assign a different QoS class (e.g., a default QoS class associated with the data flow).

The condition for QoS classification may be based on a systematic PDU within a PDU set such as the possibility of transmission/inclusion of buffered data of a systematic frame/data unit within a data flow (e.g., source data units that are encoded, systematic video frames, etc.).

The condition for QoS classification may be based on whether one or more control plane events have occurred. For example, the QoS classification may be based on one or more mobility event conditions being satisfied, or based on a condition for a conditional handover to one or more handover candidates being satisfied. For example, upon the occurrence of a mobility event, an RLM event, a beam failure event, or an RLF event, the WTRU may associate a different QoS class with a data unit, possibly for a period of time associated with the event.

The condition for QoS classification may be based on sensing an object or determining an outcome from a sensing or positioning procedure. For example, sensing data may be configured or pre-associated with a given QoS class, and upon detection of an object as a function of sensing or a spatial computing service as an outcome of sensing, a WTRU may select a certain QoS class (e.g., a non-default or configured QoS class).

The condition for QoS classification may be based on the dropping or addition of one or more data flows. For example, upon adding or dropping a service or data flow (e.g., from a multi-modal service or session), a WTRU may change the QoS class associated with the remaining data flow or a dependent data flow.

The condition for QoS classification may be based on synchronization between data flows. If the synchronization between the data flows is configured or indicated by an application or a core network, a WTRU may associate a QoS class with a data unit when a dependent data flow is synchronized, and the WTRU may associate another QoS class with a data unit when the data flows are not synchronized or within a period of miss-synchronization (e.g., a remaining synchronization time is larger or lower than a threshold). If a common identifier is used (e.g., signaled from the application or the core network) to associate two data flows, the WTRU may use the same QoS class for data units of both data flows. Once dissociated, the WTRU may revert to the default QoS classes configured for each data flow individually.

The condition for QoS classification may be based on the dropping or addition of one or more dependent data types. If a WTRU is configured to use X out of Y data units to decode an overall packet (e.g., an FEC encoded packet, a source video frame, etc.), the WTRU may select a first QoS class when X out Y data units have been successfully decoded, and the WTRU may select a second QoS class when X out of Y data units have not been successfully decoded, if X out of Y data units have been received, and/or if X data units have been received but not acknowledged.

The condition for QoS classification may be based on the occurrence of one or more events from a transport layer protocol (e.g., the generation of a TCP ACK, the transmission of an out of order packet within a transport protocol session/connection, the reading of a specific value from the header of the transport layer protocol for a given packet, etc.). Once such a condition is met, the WTRU may associate the data unit of a related RAN data flow with a given QoS class. The WTRU may be able to determine one or more properties of the transport layer protocol from a relay on top of a RAN protocol stack, which may be used to de-cypher and/or decrypt a transport layer header and/or content if it is encrypted.

The condition for QoS classification may be based on a measurement (e.g., a channel measurement) being below or above a given threshold, or based on a change in a measurement being below or above a given threshold. Once such a condition is met, the WTRU may associate a data unit with a given QoS class.

The condition for QoS classification may be based on whether a data unit is transmitted initially or retransmitted, based on the number of retransmissions, based on the energy saving state of the network (e.g., which may be indicated to a WTRU), or based on the power saving state of a WTRU (e.g., whether DRX is used).

The condition for QoS classification may be bound for a period of time (e.g., once satisfied, the condition may be considered satisfied until the period of time has elapsed). The period of time may be configured or predetermined. While the condition is met during the period of time, a differentiated QoS class may be applied to a data unit. Once the period of time expires, the data unit may be associated with a default QoS class or a QoS class that was assigned to the data unit before the condition was met. The condition may be bound to a set of data flows (e.g., a QoS flow, a data unit set, a DRB, an LCH, an LCG, a PDU set, etc.). Once satisfied, the WTRU may determine that the condition is applicable to the set of data flows (e.g., the data flows may be configured via higher layer signaling) and/or that an associated QoS class is applicable to the set of data flows. The condition may be bound to a set of data types (e.g., control data, user data, system data, intelligence data (AI/ML), positioning data, sensing data, etc.). Once satisfied, the WTRU may determine that the condition is applicable to the set of data types (e.g., the data types may be configured by higher layer signaling) and/or that an associated QoS class is applicable to the data types. The condition may be bound to a set of device capabilities, a set of uplink grants, a set of grant types (e.g., dynamic, semi-static, or configured grants), a set of grant indication properties, and/or a set of grant scheduling indications (e.g., certain DCI indications or DCI scheduling parameters).

A WTRU may perform or apply sub-TB data allocation (e.g., allocate data bits based on a unit size that may be smaller than a signaled or configured TBS), and/or select a grant from multiple grants, based on one or more of the following conditions.

The conditions for sub-TB data allocation or grant selection may include channel conditions or changes to them (e.g., movements of a WTRU, changes to a measurement being greater or less than a threshold, etc.). If these conditions are satisfied, the WTRU may perform sub-TBS allocation, which may improve the likelihood of success for data retransmissions (e.g., if the unit size or TB size is larger than a threshold). For example, the WTRU may perform sub-TB data allocation or select grants of sub-TB sizes if a measured channel condition is less than a first threshold or greater than a second threshold. Examples of these channel conditions or measurements may include an RSRP, an RSRQ, channel occupancy, or changes in any of them.

The conditions for sub-TB data allocation or grant selection may be related to the QoS class of the data available for transmission. For example, a WTRU may use sub-TB allocation or select grants of sub-TB sizes if buffered data (or data to be multiplexed) is associated with a certain QoS class, or not associated with a certain QoS class. For example, the WTRU may use sub-TB allocation or select grants of sub-TB sizes if the WTRU does not have data buffered from QoS class<=1.

The conditions for sub-TB data allocation or grant selection may be related to the priority of data (e.g., criticality, latency, or reliability of the data, data type, control information or MAC CEs to transmit, etc.). For example, a WTRU may conditionally allocate data bits only if the data is associated with certain configured LCHs or certain data flows, if the data has a priority greater than a threshold, if the data has a certain QoE level or QoS class, if certain MAC CEs exist (e.g., of a higher priority than data), or if UCI on a PUSCH exists. In examples, the WTRU may allocate data for certain MAC CEs (or a subset of MAC CEs of higher priority than data) regardless of whether the conditions of sub-TB data allocation are met, and the WTRU may multiplex lower priority MAC CEs (e.g., allocate data bits to them under a grant) only if the conditions for sub-TB data allocation are met (e.g., PH>a threshold). If data from certain LCHs, flows, priorities, or MAC CEs exist, the WTRU may forgo the conditions for sub-TB data allocation.

The conditions for sub-TB data allocation or grant selection may be based on a TBS being greater or smaller than a threshold, based on a power headroom being greater or smaller than a threshold, or based on the energy state of a network and/or a WTRU. For example, the WTRU may allocate additional data bits (e.g., non-compliant data bits) if the QoS class, priority, or delay is of a certain value (e.g., during stage 2 of an LCP procedure, as described herein).

The conditions for sub-TB data allocation or grant selection may be a function of a property of the scheduling information associated with an uplink grant. For example, a WTRU may determine the number of sub uplink grants to select from, and/or the sub-TB data allocation unit sizes as a function of the time/frequency domain allocation of a scheduled grant.

The conditions for sub-TB data allocation or grant selection may be based on reception of an indication in the DCI that schedules a grant. For example, such an indication may indicate whether to use sub-TBS allocation, whether to select among a plurality of UL grants within an indicated TB size, or whether multiple parts of a TB may be blind decoded separately by a base station.

The conditions for sub-TB data allocation or grant selection may be based on a tx power per data bit, frequency unit, or PRB (e.g., mW/bit, mW/Hz, or mW/PRB). For example, a WTRU may allocate more bits into a TB (e.g., based on a grant) if the tx power per data bit is higher than a threshold.

A WTRU may evaluate the conditions described herein prior to multiplexing data, constructing a TB, or running an LCP procedure. The WTRU may evaluate these conditions during certain procedures (e.g., step 2 of an LCP). The WTRU may evaluate these conditions continuously upon multiplexing an SDU to a TB or assigning data from an LCH or flow to a grant (e.g., based on a priority order). The WTRU may evaluate these conditions after allocating X data bits, where X may be a configured value, the number of data bits in a single PUSCH PRB, or a configured number resembling a TB data allocation unit or step size.

A WTRU may be configured with one or more unit sizes for allocating data within a TB. For example, for a TB size of A (or a range of TB sizes, where N>A>M), the WTRU may be configured with partial TB parts or sizes such as parts a0 to a1, a1 to a2, . . . , A-X to A, which the WTRU may use for sub-TB data allocation. The WTRU may gradually allocate data (e.g., multiplexing data from different LCHs) into the TB by filling data into these sub-TB parts or units (e.g., one at a time), with the assumption that a network device may blindly decode these parts or units jointly and/or separately. The sub-TB parts or units may granularized as one or more PRBs, for example.

The sub-TB units or parts may also be understood as step sizes (X) for allocating data into a TB. For example, the WTRU may assume that it may increase data allocation within a TB gradually at a step size of X, and that a network device may blindly decode the TB in multiples of X. For example, for an uplink grant of size A, the WTRU may start allocating data by chunks of X (e.g., X bits) until A is reached or until conditions for the sub-TB data allocation are no longer met. The value of X may be configured (e.g., semi-statically or semi-persistently) or determined based on other transmission parameters (e.g., based on the SDU size of an LCH or data flow involved in data multiplexing).

In examples, the WTRU may treat each TB size as a different grant, possibly conditioned on receiving an indication to do so via DCI or other network signaling (e.g., RRC signaling), and/or conditioned on having scheduling information that overlaps in frequency and/or time domains.

The WTRU may allocate (e.g., multiplex) data for an uplink grant or select an uplink grant based on sub-TB unit sizes if one or more conditions are met, where the one or more conditions may be configured per grant type, per WTRU, per QoS class, and/or per LCH or flow. If the applicable conditions are not met, the WTRU may refrain from allocating additional data and assume that the remaining grant is unallocated (e.g., the WTRU may pad parts of the TB associated with the unallocated grant so that they do not consume transmission power). In examples, the unallocated bits within the grant (e.g., padding bits) may be transmitted as zeros via an OFDM transmitter at the WTRU, or the WTRU may consider the effective TBS of the PUSCH transmission as only comprising allocated PRBs. The WTRU may granularize data allocation (e.g., during LCP) in units of PUSCH bits/PRB and may evaluate (e.g., re-evaluate) the conditions for sub-TB allocation and/or grant selection after a number of data bits has been allocated (e.g., after the number of data bits excluding control overhead equal to a single PRB has been allocated). The WTRU may allocate data based on a configured unit size or step size (e.g., X bits per allocation).

In examples, the WTRU may allocate (e.g., multiplex) data on a grant until a power headroom becomes less than a threshold value (e.g., the data allocation may be performed while the powerhead is greater than the threshold). The WTRU may evaluate this condition for each SDU that is multiplexed, for each LCH or data flow, for each LCP step or only in some LCP steps (e.g., step 2/stage 2 of an LCP or resource allocation procedure). The WTRU may evaluate the condition only for a subset of LCHs for which the condition is configured for (e.g., the WTRU may multiplex data without any restriction except for abiding to a configured traffic shaper for higher priority data flows or LCHs).

In examples, the WTRU may multiplex data on a grant until a unit tx power (e.g., mW/bit, mW/Hz or mW/PRB) becomes less than a threshold (e.g., the data allocation may be performed while the unit tx power is greater than the threshold). The WTRU may compute the unit Tx power by dividing the transmission power of the WTRU by the number of allocated or multiplexed data bits, and the WTRU may continue to allocate or multiplex data bits into a TB until the unit tx power reaches the threshold (e.g., which may indicate that a maximum power is used).

The WTRU may send an indication (e.g., as part of a TB header or sub-header, via UCI, via a MAC CE, by multiplex a DMRS on a PUSCH) to the network to indicate the sub-TB units (e.g., size of the unit, the number of units filled, etc.) used to construct a TB. For example, for a (e.g., each) TB, the WTRU may indicate the chosen sub-TB unit size and/or number of the units that are used (e.g., the largest TB part used during data allocation or multiplexing). As another example, for a (e.g., each) TB part, the WTRU may include an indication (e.g., in a sub-header) of whether the part is used for data allocation or multiplexing, assuming that the part may be decodable by the network without having to decode the whole TB.

A WTRU may realize sub-TB data allocation through grant selection amongst multiple of grants, MCSs, and/or sub-TB unit sizes. For examples, if the WTRU receives multiple grants of different sizes, the WTRU may select one of the grants according to one or more of the conditions described herein. The multiple grants, MCSs, or sub-TB unit sizes may be signaled or configured to the WTRU. For example, the WTRU may receive an explicit indication via DCI about alternative sub-TB sizes, alternative grants, and/or associated resource allocations. The DCI may signal multiple grants or different time domain resource allocations (TDRA) values associated with the grants from which the WTRU may select. As another example, the WTRU may determine different sub-TB unit sizes, alternative grants, and/or associated resource allocations from a single grant or resource allocation signaled via DCI. The WTRU may determine sub-TB size options from the MCSs associated with a signaled grant. The WTRU may use a mapping function, a resource offset, or a subset of signaled PRBs to determine the alternative grants to select from, where each alternative grant may contain a subset of PRBs or resources from those signaled for the single grant.

To determine the sub-TB unit size or grant size to select amongst a plurality of grants, the WTRU may start with the smallest sub-TB unit size, allocate data bits based on that sub-TB unit size, then evaluate conditions for using the sub-TB size and/or making a grant selection. If the conditions for the sub-TB size and/or grant selection are met, the WTRU may continue to the next (e.g., larger) sub-TB unit size or the next grant associated with the next sub-TB unit size, and so on. The WTRU may select the largest grant size or sub-TB unit size amongst those indicated or determined to meet the conditions. Once the conditions are no longer met (e.g., the power headroom of the WTRU becomes lower than a threshold), the WTRU may refrain from using a grant or allocating more data for a grant.

In examples, the WTRU may assume that resource allocation is the same (e.g., instead of changing the PRBs or resource allocation of a selected grant), but may change an MCS or waveform (e.g., while keeping the same number of PRBs). For instance, the WTRU may be configured or signaled with multiple MCSs to apply for a given uplink grant or the WTRU may derive the multiple MCSs (e.g., based on one or more configured scaling factors). The WTRU may then determine TBS1 for MCS1, TBS 2 for MCS2, TBS3 for MCS3 and so on, where TBS1>TBS2>TBS3 and MCS3 may be the most reliable one. The WTRU may perform rate matching to match the number of data bits to a selected sub-TB unit size of a selected MCS of a selected grant. When referred to herein, an MCS may determine or include a waveform used for transmission.

In examples, the WTRU may assume that the TBS is the same (e.g., instead of changing the TBS, PRBs or resource allocation of a selected grant), but may change the number of repetitions. For instance, the WTRU may receive DCI signaling that a number of repetitions may be possible, and the WTRU may select the number of repetitions based on conditions for using the TB size or making a grant selection (e.g., based on channel conditions and/or power headroom). The WTRU may select the lowest number of repetitions amongst those indicated or determined as capable of meeting the conditions for the TB size or grant selection.

In examples, the WTRU may assume that the TBS is the same (e.g., instead of changing the TBS, PRBs or resource allocation of a selected grant), but may change the number of MIMO layers or spatial streams. For instance, the WTRU may receive DCI signaling a number of MIMO layer possibilities (e.g., a number of spatial streams), and the WTRU may select the number of MIMO layers based on conditions for using the TB size or making a grant selection (e.g., based on channel conditions and/or power headroom). The WTRU may select the highest number of MIMO layers amongst those indicated or determined as capable of meeting the conditions for the TB size or grant selection. The WTRU may produce a TB for each selected MIMO layer.

In examples, the WTRU may receive a plurality of grants, possibly overlapping in the time and/or frequency domain, with the same or different TB sizes and/or MCSs. The grants may be modelled as multiple grants derived from a single signaled grant. The WTRU may also receive or be configured with other parameters including, for example, a number of repetitions, a number of MIMO layers, a number of slots, a number of PRBs, etc. Out of the plurality of grants, the WTRU may select a grant if the selection keeps the power headroom of the WTRU above a threshold or if the selection satisfies other conditions or criteria for using a TB size or making the grant selection (e.g., these other selection criteria may include a tx power per data bit or information bit (mW/bit), a PSD (mW/Hz), or a tx power per PRB (mW/PRB).

In examples, the WTRU may receive from the network one grant with multiple MCS/TBS values (e.g., instead of changing PRBs), and the WTRU may select the MCS and keep the same PRBs based on the MCS value that may keep the power headroom of the WTRU above a threshold. The WTRU may perform rate matching and/or data multiplexing based on the selected MCS.

In examples, the WTRU may receive (e.g., via DCI or a semi-static configuration) a value for Bj or minTBS per grant, which the WTRU may use in a first step for shaping compliant traffic. The WTRU may allocate data beyond minTBS if one or more conditions for using a TB size or making a grant selection are met. The minTBS may act as an overall shaper and the WTRU may multiplex non-compliant traffic beyond minTBS (e.g., up to a grant TBS) if the conditions for using a TB size or making a grant selection are met. One or more of the conditions may be applicable once the WTRU allocates minTBS bits, where minTBS may be configured via RRC signaling (e.g., for certain grant types) or be signaled in the DCI for a given uplink grant.

In examples, the WTRU may allocate (e.g., multiplex) data on a grant up to minTBS without checking the conditions for using a TB size or making a grant selection. In examples (e.g., in one or more of LCP step 1, step 2, or step 3), the WTRU may allocate or multiplex data bits if (e.g., only if) an applicable condition is met. As described herein, these conditions may be based on the power headroom of the WTRU, the priority of data, a QoS class, the latency or remaining time associated with buffered data, etc. In examples, minTBS may be used in (e.g., only in) step1 and/or step 2 of an LCP procedure.

In examples, a network device may signal a minTBS or an overall Bj to shape one or more (e.g., all) LCHs associated with a TB for a reported powerhead room, and the WTRU may multiplex data beyond minTBS if a computed power headroom does not fall below a threshold (e.g., during step 1 and/or step 2 of an LCP procedure). This may act as an implicit reporting of the power headroom to the network device (e.g., as an up/down PH step), possibly without transmitting a PHR MAC CE. If the WTRU's power headroom has reached the threshold, the WTRU may not transmit (e.g., multiplex) a PHR MAC CE even if a PHR is triggered, as the scheduler may be able to determine that the power headroom is at the threshold (e.g., for a concerned cell or a single entry PHR). This may be done when (e.g., only when) the WTRU has allocated bits beyond minTBS. The WTRU may trigger a new PHR and may multiplex a PHR MAC CE if the WTRU has allocated bits up to minTBS and the power headroom has risen above the threshold.

In examples, the WTRU may receive an uplink grant along with an associated minTBS value to shape data allocation from one or more (e.g., all) LCHs in a TB for a reported power headroom. The WTRU may allocate data from one or more LCHs based on a set of rules (e.g., priority first, up to Bj/PBR in LCH step 1, etc.) until a minTBS number of bits or a minPRB number of PRBs is allocated on a grant. For the remaining space in the grant beyond minTBS or minPRB, the WTRU may multiplex data on the grant while the power headroom of the WTRU is above a threshold or while other conditions for performing sub-TB data allocation are met. The WTRU may not spend transmission power on unallocated bits of the grant (e.g., the WTRU may treat the unallocated bits as zero-power padding bits by dropping PRBs associated with the unallocated bits from transmission). The WTRU may granularize the data allocation in units of PUSCH bits/PRB or MCS steps. The WTRU may omit a PHR MAC CE if the power headroom of the WTRU reaches the threshold (e.g., this may act as implicit up/down PH step reporting). The WTRU may pad unallocated parts of a TB. The WTRU may skip the uplink grant and/or transmit a UCI-UTO if minTBS number of bits cannot be allocated without meeting the sub-TB data allocation conditions (e.g., without having the PH falling below the threshold).

In examples, if the WTRU determines that a network device and/or the WTRU itself is an active energy saving state (e.g., in cell DRX, cell DTX, reduced blind detection at the network, WTRU C-DRX, etc.), the WTRU may skip one or more uplink grants (e.g., not use them to multiplex data), for example, if a condition for sub-TB data allocation is not met. For instance, the WTRU may skip an UL grant if the WTRU determines that it or the network is in a power saving state, if the WTRU does not have latency-critical data to transmit, if the data to be transmitted is not from a certain QoS class, and/or if the remaining time associated with a buffered data PDB is larger than a threshold. The WTRU may determine that the network is in the energy saving state based on reception of an activation signal (e.g., via RRC, DCI, paging, a certain RNTI or DCI format, or a MAC CE). The WTRU may determine that the network is in the energy saving state based on reception of a common signal and channel with a certain physical property (e.g., based on a periodicity, sequence, or sequence value associated with the signal or channel). The WTRU may determine that the network is in the energy saving state if the WTRU does not receive an expected common signal or channel. For example, the WTRU can be configured to skip a grant if there is no high priority data, control information or MAC CE to multiplex (e.g., if there is no data or control information with a higher LCP priority than user plane data).

In examples, the WTRU may use a first configured value for a PBR or BSR (e.g., PBR1 or BSD1) to update a bucket (e.g., Bj) if the network and/or the WTRU is in an active energy saving state. The WTRU may use a second configured value for PBR or BSR (e.g., PBR2 or BSD2) to update the Bj if the network and/or the WTRU is in a normal state (e.g., with energy saving deactivated). In an energy saving state, the WTRU may not exceed a selected value of Bj and may allocate resources in a single step.

In examples, the WTRU may be configured with a plurality of PBR and/or BSD values, wherein the specific values to be used by the WTRU may depend on whether a sub-TB data allocation condition is met or not. For example, the WTRU may change or select the value to use for a PBR/BSD (e.g., for shaping data or multiplexing data on a given grand) based on one or more power headroom and/or channel related conditions. The WTRU may inform an upper layer (e.g., an application or a RAN-application API) upon changing or selecting the value.

A network device may determine whether a WTRU has used certain scheduled PRBs for a given grant. The network device may avoid unused PRBs in the process of soft combining. The WTRU may help the network device determine the number of used PRBs, a unit size for sub-TB data allocation, and/or other grant selected parameters (e.g., TBS, MCS, rank, MIMO layers, etc.) via one or more of the following.

The WTRU may send an indication to the network device, for example, in a header or sub-header. The WTRU may be configured with a TB part that includes the header or sub-header and may use the header or sub-header to indicate a selected grant or sub-TB unit size. The header or sub-header may be decoded separately from the rest of the TB. The WTRU may encode the header or sub-header with a CRC check separate from that of the TB. The WTRU may use the same HARQ process or a different HARQ process for the header or the sub-header than for the rest of the TB. The WTRU may receive separate feedback for the header or sub-header, and as such may retransmit the header or sub-header separately from the rest of the TB.

If the WTRU multiplexes data on a part of the TB(s) or PRB(s) associated with a grant, the WTRU may multiplex a control element (e.g., a MAC CE) or UCI on the same PUSCH transmission to indicate the number of used PRBs, one or more grant parameters, and/or the TBS/MCS/rank used for the transmission. The WTRU may be configured (e.g., via semi-static or RRC signaling) with a discrete number of possibilities for sub-PRB allocation (e.g., 100% of PRBs or 50% of PRBs, which may be rounded up or down), and a network device (e.g., a base station) may perform blind decoding on the configured possibilities.

A network device (e.g., a base station) may signal (e.g., via DCI) a plurality of possible combinations for TBS/PRB data allocation, and a WTRU may select a combination from the signaled options. The network device may then perform blind decoding on the signaled options if UCI is not detected. The DCI may include a number of parameters (e.g., MCS, waveform, MIMO layers, etc.) that may change from a grant allocation perspective. Multiple grants may have the same HARQ process.

A WTRU may indicate a selected TBS, grant, and/or grant parameter using a selected DMRS, modulation, or waveform. For example, a DMRS sequence may be used to indicate which one or more scaling factors were used for scaling a TBS. The DMRS may indicate which subset of grant parameters signaled in DCI were used in an initial TB. The DMRS sequence may be mapped to TB transmission information.

A WTRU may be configured to use a first number of symbols (e.g., first X symbols) of a slot to transmit a preamble (e.g., from a set of preambles) that may indicate which TB unit size is used for a transmission.

Soft combining may be enabled if an initial TB unit size is not known by a network device with certainty. For example, if a WTRU has selected sub-TB allocation for the initial TB (e.g., using a TB size smaller than that indicated for a grant, using a subset of scheduled PRBs, using a lower number of MIMO layers, etc.), the WTRU may not change the TB size for retransmissions.

If a retransmission is signaled for a TB for which sub-TB data allocation is performed, the WTRU may construct the TB for retransmission using the full TB size (e.g., using the same TBS signaled for the initial transmission). The TB transmitted initially may be front-loaded in the retransmission TB and additional padding bits may be added to match the TBS signaled for the initial grant (e.g., the max TBS among possible choices). The WTRU may include a padding MAC CE that may indicate which TBS was selected for the previous transmission (e.g., the initial transmission) that does not match the size of the retransmitted TB. The MAC CE may indicate the TB portions and/or PRBs used in the previous transmission, which may be used by a network device to enable soft combining. If the WTRU increases the TBS for a retransmission, the WTRU may assume that the same size is not changed (e.g., the max TBS) unless the WTRU is told otherwise by the network device (e.g., via an indication in DCI).

For retransmissions, the network device may signal an absolute value for TBS/PRB allocation. If the TB size for the initial TB (e.g., TBS (initial TB) is greater than the TB size for a retransmission (e.g., TBS (retrx)), the WTRU may perform a CBG-based retransmission on the signaled TBS (retx) or the WTRU may reconstruct the TB (e.g., by triggering an RLC retransmission or a transmission from a retransmission layer above HARQ). The WTRU may send an indication that it has more data to retransmit in such a case. In examples, a MAC PDU may be partially retransmitted if the grant size is smaller, and the WTRU may indicate that the MAC has segmented the MAC PDU. The WTRU may multiplex a (e.g., additional) header to indicate the segment size. This may be useful at least when there are not many CBG based transmissions (e.g., when the TBS is small).

If TBS (initial TB) is smaller than TBS (retx), the WTRU may add padding bits to the retransmitted TB and/or send an indication (e.g., by multiplexing a MAC CE) to a base station that there may be a mismatch in TBS. The base station may use DCI to indicate multiple grants for retransmissions. The WTRU may indicate a selected TB unit size by selecting the grant that matches the TB size of the initial TB, and/or by transmitting UCI or a DMRS that indicates the selection.

If the WTRU has used a subset of PRBs or sub-TB data allocation, or if a real PUSCH power headroom is above 0, or if the WTRU uses a subset of assigned PRBs in a designated grant or configured grant, the WTRU may adjust the PUSCH transmit power to:

$${P}_{PUSCH , b , f , c} ( i , j , {q}_{d} , l ) = min \{ \begin{matrix}{P}_{CMAX , f , c} ( i ) , \\ {P}_{O\_PUSCH , b , f , c} ( j ) + 10 {log}_{10} ( {2}^{μ} \cdot {M}_{RB , b , f , c}^{PUSCH} ( i ) ) + {α}_{b , f , c} ( j ) \cdot {PL}_{b , f , c} ( {q}_{d} ) + {Δ}_{TF , b , f , c} ( i ) + {f}_{b , f , c} ( i , l )\end{matrix} \}$$

where M′_{RB,f,c} may be the number of PRBs with multiplexed data. If the power headroom is <=0 (or less than a threshold), the WTRU may use a regular M_{RB,f,c} and the PUSCH power may be allocated only to a subset of PBRs on which data is multiplexed.

If the WTRU has used a subset of PRBs or sub-TB data allocation, the TBS may be reduced (whereby the WTRU may select among multiple sub-TB unit sizes) and some PRBs may not be used at all. This may increase the power per information or data bit for the allocated PBRs, and the WTRU may compute the power headroom based on the actual number of bits/PRBs allocated rather than a scheduled TBS and/or a number of PRBs allocated by a grant.

In one or more of the examples described herein, if the WTRU has used a subset of PRBs or a TB unit size lower than a signaled TBS for a grant, the WTRU may perform CB or CBG based PUSCH (re)-transmissions, such that the WTRU MAC layer may build the TB, but the WTRU PHY layer may transmit the MAC PDU plus one or more additional bits. These additional bits may not be actually transmitted if a CBG-based transmission is performed, though the overall TB size may match the signaled TBS. This may resemble a CBG-based transmission for an initial transmission.

According to embodiments of the disclosure, a WTRU may be configured to receive an uplink transmission grant from a network device and determine a threshold condition associated with allocating data based on a sub-transport block (sub-TB) unit size. Based on a determination that the threshold condition is satisfied if a first set of data is allocated to a first portion of a transport block (TB) and a second set of data is allocated to a second portion of the TB, the WTRU may allocate the first set of data to the first portion of the TB and the second set of data to the second portion of the TB, wherein at least one of the first portion or the second portion of the TB may have a size equal to the sub-TB unit size. The WTRU may then transmit the TB using the uplink transmission grant and based on the sub-TB unit size.

In examples, the WTRU may be further configured to receive configuration information from the network device that may indicate the sub-TB unit size. In examples, the threshold condition may be related to a transmission power of the WTRU, and the threshold condition may be determined to be satisfied if a power headroom of the WTRU is above a threshold value. In examples, the threshold condition may be determined to be satisfied by calculating an amount of transmission power allocated to a unit of data (e.g., a data bit or a physical resource block) in the TB, and determining that the amount of transmission power is above a threshold value.

In examples, the threshold condition may be further related to a mobility state of the WTRU or a channel measurement of the WTRU. In examples, the WTRU may determine that the threshold condition is satisfied further based on a determination that the first set of data and the second set of data may be associated with a specific data type or a specific priority. In examples, the WTRU may determine that the threshold condition is satisfied further based on a determination that the first set of data and the second set of data may be associated with a specific logical channel or a specific quality of service (QoS) requirement.

In examples, the WTRU may be further configured to transmit an indication to the network device that the transmission of the TB is based on the sub-TB unit size. In examples, the uplink transmission grant may be large enough to accommodate a third portion of the TB and, based on a determination that the threshold condition is no longer satisfied, the WTRU may pad the third portion of the TB so that it does not consume transmission power (e.g., the WTRU may exclude one or more physical resource blocks (PRBs) associated with the third portion from the transmission of the TB).

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a solid state drive, register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, a terminal, a base station (e.g., a gNB), a control unit, a data unit, an RNC, and/or any host computer.

1. A wireless transmit/receive unit (WTRU), comprising:
a processor configured to:
receive an uplink transmission grant from a network device;
determine a threshold condition associated with allocating data based on a sub-transport block (sub-TB) unit size;
based on a determination that the threshold condition is satisfied if a first set of data is allocated to a first portion of a transport block (TB) and a second set of data is allocated to a second portion of the TB, allocate the first set of data to the first portion of the TB and the second set of data to the second portion of the TB, wherein at least one of the first portion or the second portion of the TB has a size equal to the sub-TB unit size; and
transmit the TB using the uplink transmission grant and based on the sub-TB unit size.

2. The WTRU of claim 1, wherein the processor is further configured to receive configuration information from the network device that indicates the sub-TB unit size.

3. The WTRU of claim 1, wherein the sub-TB unit size is smaller than a transport block size (TBS) configured for the uplink transmission grant.

4. The WTRU of claim 1, wherein the threshold condition is related to a transmission power of the WTRU.

5. The WTRU of claim 4, wherein the threshold condition is determined to be satisfied if a power headroom of the WTRU is above a threshold value.

6. The WTRU of claim 4, wherein the processor is configured to calculate an amount of transmission power allocated to a unit of data in the TB, and determine that the threshold condition is satisfied if the amount of transmission power is above a threshold value.

7. The WTRU of claim 6, wherein the unit of data is a data bit or a number of data bits included in a physical resource block.

8. The WTRU of claim 4, wherein the threshold condition is further related to a mobility state of the WTRU or a channel measurement of the WTRU.

9. The WTRU of claim 4, wherein the processor is configured to determine that the threshold condition is satisfied further based on a determination that the first set of data and the second set of data are associated with a specific data type or a specific priority.

10. The WTRU of claim 4, wherein the processor is configured to determine that the threshold condition is satisfied further based on a determination that the first set of data and the second set of data are associated with a specific logical channel or a specific quality of service (QoS) requirement.

11. The WTRU of claim 1, wherein the processor is further configured to transmit an indication to the network device that the transmission of the TB is based on the sub-TB unit size.

12. The WTRU of claim 1, wherein the uplink transmission grant is large enough to accommodate a third portion of the TB, and wherein, based on a determination that the threshold condition is no longer satisfied, the processor is further configured to exclude one or more physical resource blocks (PRBs) associated with the third portion from the transmission of the TB.

13. A method implemented by a wireless transmit/receive unit (WTRU), the method comprising:
receiving an uplink transmission grant from a network device;
determining a threshold condition associated with allocating data based on a sub-transport block (sub-TB) unit size;
based on a determination that the threshold condition is satisfied if a first set of data is allocated to a first portion of a transport block (TB) and a second set of data is allocated to a second portion of the TB, allocating the first set of data to the first portion of the TB and the second set of data to the second portion of the TB, wherein at least one of the first portion or the second portion of the TB has a size equal to the sub-TB unit size; and
transmitting the TB using the uplink transmission grant and based on the sub-TB unit size.

14. The method of claim 13, further comprising receiving configuration information from the network device that indicates the sub-TB unit size.

15. The method of claim 13, wherein the threshold condition is related to a transmission power of the WTRU.

16. The method of claim 15, wherein the threshold condition is determined to be satisfied if a power headroom of the WTRU is above a threshold value.

17. The method of claim 15, wherein the threshold condition is determined to be satisfied by calculating an amount of transmission power allocated to a unit of data in the TB, and determining that the amount of transmission power is above a threshold value.

18. The method of claim 15, wherein the threshold condition is further related to a mobility state of the WTRU, a channel measurement of the WTRU, or respective types, priorities, logical channels, or quality of service requirements of the first set of data and the second set of data.

19. The method of claim 13, further comprising transmitting an indication to the network device that the transmission of the TB is based on the sub-TB unit size.

20. The method of claim 13, wherein the uplink transmission grant is large enough to accommodate a third portion of the TB, and wherein, based on a determination that the threshold condition is no longer satisfied, one or more physical resource blocks (PRBs) associated with the third portion of the TB are excluded from the transmission of the TB.
